(19) United States
(12) Patent Application Publication
(10) Pub. No.: US 2026/0212534 A1
(43) Pub. Date: Jul. 23, 2026

(54) INTER PREDICTION BUFFER GENERATION FOR POINT CLOUD COMPRESSION

(71) Applicant: QUALCOMM Incorporated, San Diego, CA (US)

(72) Inventors: Adarsh Krishnan Ramasubramonian, Irvine, CA (US); Geert Van der Auwera, San Diego, CA (US); Anique Akhtar, San Diego, CA (US); Reetu Hooda, San Diego, CA (US); Marta Karczewicz, San Diego, CA (US)

(21) Appl. No.: 19/450,156

(22) Filed: Jan. 15, 2026

Related U.S. Application Data
(60) Provisional application No. 63/746,850, filed on Jan. 17, 2025.
(60) Provisional application No. 63/748,291, filed on Jan. 22, 2025.
(60) Provisional application No. 63/782,474, filed on Apr. 2, 2025.
(60) Provisional application No. 63/836,993, filed on Jul. 1, 2025.

(51) Int. Cl. G06T 9/00; G06T 17/00

(52) U.S. Cl. CPC G06T 9/00; G06T 17/00; G06T 2210/56

(57) ABSTRACT

A device for processing point cloud data is configured to determine a first decoded frame of the point cloud data; generate, from points of the first decoded frame, a geometry reference buffer; generate, from the points of the first decoded frame, an attribute reference buffer that is separate from the geometry reference buffer and having an ordering of reference points in the attribute reference buffer is different than an ordering of reference points in the geometry reference buffer; determine a predicted geometry value for a point in a second decoded frame of the point cloud data from the geometry reference buffer; determine a predicted attribute value for the point in the second decoded frame of the point cloud data from the attribute reference buffer; and determine a final version of the second decoded frame of the point cloud data based on the predicted geometry value and the predicted attribute value.

This application claims the benefit of:
U.S. Provisional Patent Application No. 63/836,993, filed 1 Jul. 2025;
U.S. Provisional Patent Application No. 63/782,474, filed 2 Apr. 2025;
U.S. Provisional Patent Application No. 63/748,291, filed 22 Jan. 2025; and
U.S. Provisional Patent Application No. 63/746,850, filed 17 Jan. 2025, the entire content of each being incorporated herein by reference.

### TECHNICAL FIELD

This disclosure relates to point cloud encoding and decoding.

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for encoding and decoding point clouds. Encoding point clouds may reduce the amount of data required for storage and transmission of point clouds.

### SUMMARY

This disclosure describes techniques for processing point cloud data by generating and maintaining separate reference buffers for geometry and attribute inter prediction. A G-PCC coder determines a first decoded frame of point cloud data and utilizes points from this frame to populate distinct storage structures. The system generates a geometry reference buffer configured to support geometry prediction, often utilizing a look-up table structure indexed by laser identification and quantized azimuth.

Distinctly, the system generates an attribute reference buffer configured to support attribute prediction. A key characteristic of this approach involves organizing the attribute reference buffer such that an ordering of reference points within the attribute reference buffer differs from an ordering of reference points within the geometry reference buffer.

To generate the attribute reference buffer, the techniques include processing points of the first decoded frame in a decoding order. The process may involve downsampling the points to create a downsampled reference frame. Crucially, the system stores the points in the attribute reference buffer in a manner that preserves the original decoding sequence, ensuring that a relative order of the points in the attribute reference buffer matches a relative order of points in the first decoded frame. Preserving the decoding order in the linear access buffer ensures that points accessed sequentially during attribute inter prediction reside in adjacent or nearby memory locations. This preservation of order significantly reduces the incidence of cache misses and lowers the computational complexity associated with accessing reference attribute data.

During the encoding or decoding of a subsequent frame, the system leverages these specialized buffers to determine predicted values. The coder determines a predicted geometry value for a point in a second frame by accessing the geometry reference buffer. Correspondingly, the coder determines a predicted attribute value for the point in the second frame by accessing the attribute reference buffer. By decoupling the buffer organizations, the disclosure optimizes the distinct data access patterns required for geometry and attribute coding, thereby improving memory management and overall coding efficiency.

According to an example of this disclosure, a device for processing point cloud data includes: a memory configured to store the point cloud data; and one or more processors, implemented in circuitry, and configured to: determine a first decoded frame of the point cloud data; generate, from points of the first decoded frame, a geometry reference buffer; generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determine a predicted geometry value for a point in a second decoded frame of the point cloud data from the geometry reference buffer; determine a predicted attribute value for the point in the second decoded frame of the point cloud data from the attribute reference buffer; and determine a final version of the second decoded frame of the point cloud data based on the predicted geometry value and the predicted attribute value.

According to an example of this disclosure, a method of decoding point cloud data includes: determining a first decoded frame of the point cloud data; generating, from points of the first decoded frame, a geometry reference buffer; generating, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determining a predicted geometry value for a point in a second decoded frame of the point cloud data from the geometry reference buffer; determining a predicted attribute value for the point in the second decoded frame of the point cloud data from the attribute reference buffer; and determining a final version of the second decoded frame of the point cloud data based on the predicted geometry value and the predicted attribute value.

A computer-readable storage medium stores instructions that when executed by one or more processors cause the one or more processors to: determine a first decoded frame of point cloud data; generate, from points of the first decoded frame, a geometry reference buffer; generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determine a predicted geometry value for a point in a second decoded frame of the point cloud data from the geometry reference buffer; determine a predicted attribute value for the point in the second decoded frame of the point cloud data from the attribute reference buffer; and determine a final version of the second decoded frame of the point cloud data based on the predicted geometry value and the predicted attribute value.

According to an example of this disclosure, a device for encoding point cloud data includes: a memory configured to store the point cloud data; and one or more processors, implemented in circuitry, and configured to: determine a first decoded frame of the point cloud data; generate, from points of the first decoded frame, a geometry reference buffer; generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determine a predicted geometry value for a point in a second frame of the point cloud data from the geometry reference buffer; determine a predicted attribute value for the point in the second frame of the point cloud data from the attribute reference buffer; and encode the point in the second frame of the point cloud data based on the predicted geometry value and the predicted attribute value.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 is a block diagram illustrating an example Geometry Point Cloud Compression (G-PCC) encoder.

FIG. 3 is a block diagram illustrating an example G-PCC decoder.

FIG. 4 is an example Octree split for geometry coding according to the techniques of this disclosure.

FIG. 5 is a conceptual diagram illustrating an example of a prediction tree, in accordance with one or more techniques of this disclosure.

FIGS. 6A and 6B are conceptual diagrams illustrating an example of a spinning LIDAR acquisition model.

FIG. 7 is a conceptual diagram illustrating an example of inter-prediction of a current point from a point in a reference frame.

FIG. 8 is a flow diagram illustrating example operation of a G-PCC decoder.

FIG. 9 is a conceptual diagram illustrating an example of an additional inter predictor point obtained from the first point that has an azimuth greater than the inter predictor point.

FIG. 10 is a flow diagram illustrating an example of motion compensation techniques where the reference frame is in the spherical domain and the motion compensation is applied in the Cartesian domain.

FIG. 11 is a conceptual diagram illustrating an example of azimuth resampling of motion compensated references.

FIG. 12 is a flow diagram illustrating an example of spherical coordinate conversion according to one or more aspects of this disclosure.

FIGS. 13 and 14 illustrate processes related to inter prediction.

FIG. 15 shows an example of a spherical table with only one point per entry.

FIG. 16 shows an example of a spherical table with multiple points per entry.

FIG. 17 shows an example process for obtaining the linear access of points in a reference frame.

FIG. 18 shows an example process for obtaining points in a reference frame according to techniques of this disclosure.

FIG. 19 is a block diagram illustrating an example geometry encoding unit of FIG. 2 in more detail.

FIG. 20 is a block diagram illustrating an example attribute encoding unit of FIG. 2 in more detail.

FIG. 21 is a block diagram illustrating an example geometry decoding unit of FIG. 3 in more detail.

FIG. 22 is a block diagram illustrating an example attribute decoding unit of FIG. 3 in more detail.

FIG. 23 is a conceptual diagram illustrating an example range-finding system that may be used with one or more techniques of this disclosure.

FIG. 24 is a conceptual diagram illustrating an example vehicle-based scenario in which one or more techniques of this disclosure may be used.

FIG. 25 is a conceptual diagram illustrating an example extended reality system in which one or more techniques of this disclosure may be used.

FIG. 26 is a conceptual diagram illustrating an example mobile device system in which one or more techniques of this disclosure may be used.

FIGS. 27A and 27B show a layer-group structure of an occupancy tree.

FIG. 28 shows some examples of different occupancy situations.

FIG. 29 is a flowchart illustrating an example process for encoding point cloud data.

FIG. 30 is a flowchart illustrating an example process for decoding point cloud data.

### DETAILED DESCRIPTION

A point cloud is a collection of points in a three-dimensional (3D) space, which are used to represent the physical content of an environment or objects within the 3D space. Point cloud data includes two main components, geometry and attributes. Geometry refers to the 3D position of each point in space. Attributes are the associated values for each point, which may include color information (e.g., RGB values), reflectance, or other such properties.

A G-PCC decoder reconstructs the geometry of a point cloud from a geometry bitstream using inter prediction and intra prediction. When decoding a frame using intra prediction, the G-PCC decoder may reconstruct the frame without reference to any previously decoded frames. When decoding a point using inter prediction, the decoder relies on information from previously decoded frames.

The G-PCC decoder uses a spherical table as a fast lookup structure to manage a reference frame. For geometry inter prediction, the decoder populates the spherical table with the spherical coordinates (radius, azimuth, and laser ID) of the points from a previously decoded reference frame. The table is indexed using the laser ID and a quantized azimuth value. When the decoder processes a new point in the current frame that is inter-predicted, the decoder uses the laser ID and quantized azimuth from a previous point to look up a corresponding anchor position in the spherical table. From this anchor, the G-PCC decoder finds one or more predictor points, such as the next point in the table with a greater azimuth value.

G-PCC decoders also use the spherical table for attribute inter prediction. G-PCC decoders, however, cannot use the laser ID and a quantized azimuth value to access the spherical table and, instead, must translate the spherical table into a linear, sequential list of points by traversing the spherical table in a specific manner. To generate this sequential list, the G-PCC decoder must access non-adjacent memory locations, which is both computationally expensive and prone to cache misses (i.e., having to read data from a slower memory due to the data not being available in a higher speed cache).

According to the techniques of this disclosure, a G-PCC decoder may be configured to maintain a linear buffer, also referred to herein as an attribute reference buffer, separate from the spherical table, also referred to herein as a geometry reference buffer. The attribute reference buffer may store points in the original decoding order, whereas the geometry reference buffer may index a laser identification value and a quantized azimuth value to a radius value and an unquantized azimuth value. A G-PCC decoder may determine a predicted geometry value for a point in a frame of the point cloud data from the geometry reference buffer and determine a predicted attribute value for the point in the second decoded frame of the point cloud data from the attribute reference buffer. By maintaining separate buffers in this manner, the disclosed techniques may ensure that points accessed sequentially during attribute inter-prediction are more likely to be stored in adjacent or nearby memory locations. This preservation of order can significantly reduce the incidence of cache misses and lower the computational complexity associated with accessing reference attribute data. Furthermore, the process avoids the overhead of reconstructing a linear order from a potentially reordered structure like the spherical table, thus simplifying the buffer generation process.

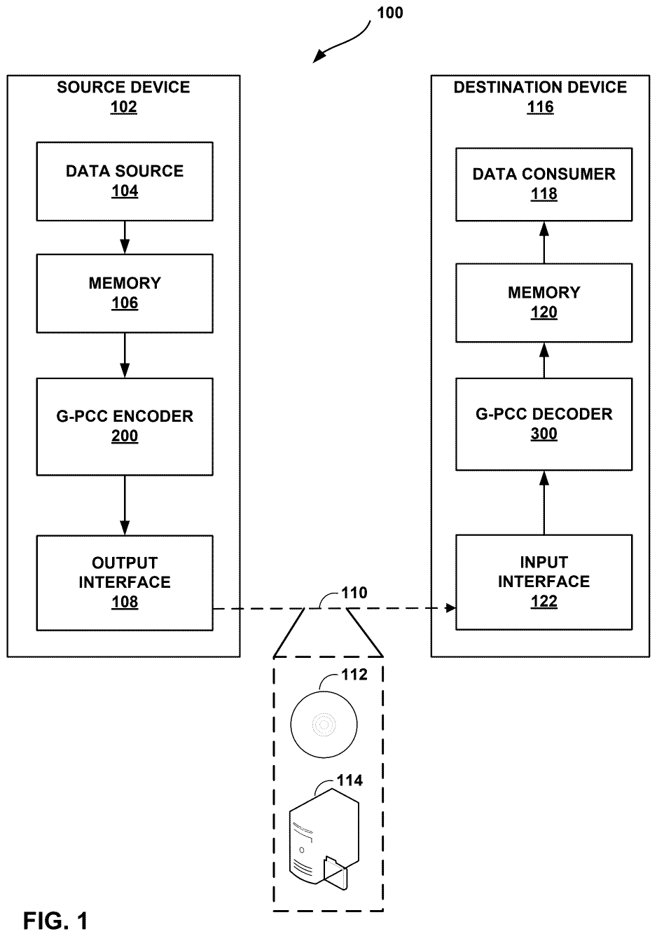

FIG. 1 is a block diagram illustrating an example encoding and decoding system 100 that may perform the techniques of this disclosure. The techniques of this disclosure are generally directed to coding (encoding and/or decoding) point cloud data, i.e., to support point cloud compression. In general, point cloud data includes any data for processing a point cloud. The coding may be effective in compressing and/or decompressing point cloud data.

As shown in FIG. 1, system 100 includes a source device 102 and a destination device 116. Source device 102 provides encoded point cloud data to be decoded by a destination device 116. Particularly, in the example of FIG. 1, source device 102 provides the point cloud data to destination device 116 via a computer-readable medium 110.

Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a G-PCC encoder 200, and an output interface 108. Destination device 116 includes an input interface 122, a G-PCC decoder 300, a memory 120, and a data consumer 118. In accordance with this disclosure, G-PCC encoder 200 of source device 102 and G-PCC decoder 300 of destination device 116 may be configured to apply the techniques of this disclosure related to buffer generation for inter prediction. Thus, source device 102 represents an example of an encoding device, while destination device 116 represents an example of a decoding device. In other examples, source device 102 and destination device 116 may include other components or arrangements. For example, source device 102 may receive data (e.g., point cloud data) from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to buffer generation for inter prediction. Source device 102 and destination device 116 are merely examples of such devices in which source device 102 generates coded data for transmission to destination device 116. This disclosure refers to a “coding” device as a device that performs coding (encoding and/or decoding) of data. Thus, G-PCC encoder 200 and G-PCC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded point cloud data) and may provide a sequential series of “frames”) of the data to G-PCC encoder 200, which encodes data for the frames. Data source 104 of source device 102 may include a point cloud capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, point cloud data may be computer-generated from scanner, camera, sensor or other data. For example, data source 104 may generate computer graphics-based data as the source data, or produce a combination of live data, archived data, and computer-generated data. In each case, G-PCC encoder 200 encodes the captured, pre-captured, or computer-generated data. G-PCC encoder 200 may rearrange the frames from the received order (sometimes referred to as “display order”) into a coding order for coding. G-PCC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from G-PCC decoder 300. Additionally or alternatively, memory 106 and memory 120 may store software instructions executable by, e.g., G-PCC encoder 200 and G-PCC decoder 300, respectively. Although memory 106 and memory 120 are shown separately from G-PCC encoder 200 and G-PCC decoder 300 in this example, it should be understood that G-PCC encoder 200 and G-PCC decoder 300 may also include internal memories for functionally similar or equivalent purposes. Furthermore, memory 106 and memory 120 may store encoded data, e.g., output from G-PCC encoder 200 and input to G-PCC decoder 300. In some examples, portions of memory 106 and memory 120 may be allocated as one or more buffers, e.g., to store raw, decoded, and/or encoded data. For instance, memory 106 and memory 120 may store data representing a point cloud.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to G-PCC encoder 200 and/or output interface 108, and destination device 116 may include an SoC device to perform the functionality attributed to G-PCC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by G-PCC encoder 200, which is also used by G-PCC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on a point cloud.

G-PCC encoder 200 and G-PCC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of G-PCC encoder 200 and G-PCC decoder 300 may be included in one or more encoders or decoders, either of which may be integrated as part of a combined encoder/decoder (CODEC) in a respective device. A device including G-PCC encoder 200 and/or G-PCC decoder 300 may comprise one or more integrated circuits, microprocessors, and/or other types of devices.

G-PCC encoder 200 and G-PCC decoder 300 may operate according to a coding standard, such as video point cloud compression (V-PCC) standard or a geometry point cloud compression (G-PCC) standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, G-PCC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

ISO/JEC MPEG (JTC 1/SC 29/WG 11) is studying the potential need for standardization of point cloud coding technology with a compression capability that significantly exceeds that of the current approaches and will target to create the standard. The group is working together on this exploration activity in a collaborative effort known as the 3-Dimensional Graphics Team (3DG) to evaluate compression technology designs proposed by their experts in this area. Recently, a new standard Enhanced G-PCC (E-GPCC) was started as an improvement/extension to the G-PCC standard. A recent version of the E-GPCC specification is available in Text of ISO/IEC CD 23090-38 Enhanced G-PCC, ISO/IEC JTC 1/SC29/WG 7 MDS24457, Kemer, Oct.-Nov., 2024.

Point cloud compression activities are categorized in two different approaches. The first approach is “Video point cloud compression” (V-PCC), which segments the 3D object and projects the segments in multiple 2D planes (which are represented as “patches” in the 2D frame), which are further coded by a legacy 2D video codec such as a High Efficiency Video Coding (HEVC) (ITU-T H.265) codec. The second approach is “Geometry-based point cloud compression” (G-PCC), which directly compresses 3D geometry i.e., position of a set of points in 3D space, and associated attribute values (for each point associated with the 3D geometry). G-PCC addresses the compression of point clouds in both Category 1 (static point clouds) and Category 3 (dynamically acquired point clouds). A recent draft of the G-PCC standard is available in G-PCC DIS, ISO/IEC JTC1/SC29/WG11 w19088, Brussels, Belgium, January 2020, and a description of the codec is available in G-PCC Codec Description v6, ISO/IEC JTC1/SC29/WG11 w19091, Brussels, Belgium, January 2020.

A point cloud contains a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

The 3D space occupied by a point cloud data may be enclosed by a virtual bounding box. The position of the points in the bounding box may be represented by a certain precision; therefore, the positions of one or more points may be quantized based on the precision. At the smallest level, the bounding box is split into voxels which are the smallest unit of space represented by a unit cube. A voxel in the bounding box may be associated with zero, one, or more than one point. The bounding box may be split into multiple cube/cuboid regions, which may be called tiles. Each tile may be coded into one or more slices. The partitioning of the bounding box into slices and tiles may be based on number of points in each partition, or based on other considerations (e.g., a particular region may be coded as tiles). The slice regions may be further partitioned using splitting decisions similar to those in video codecs.

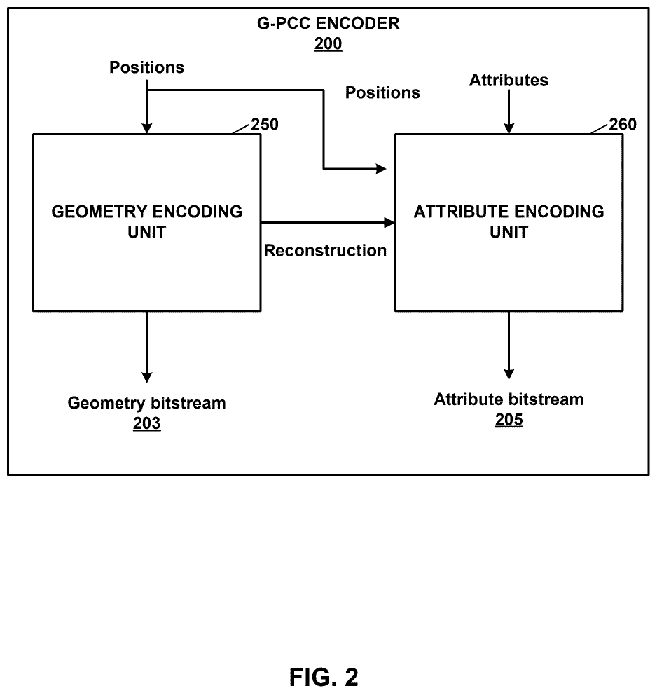

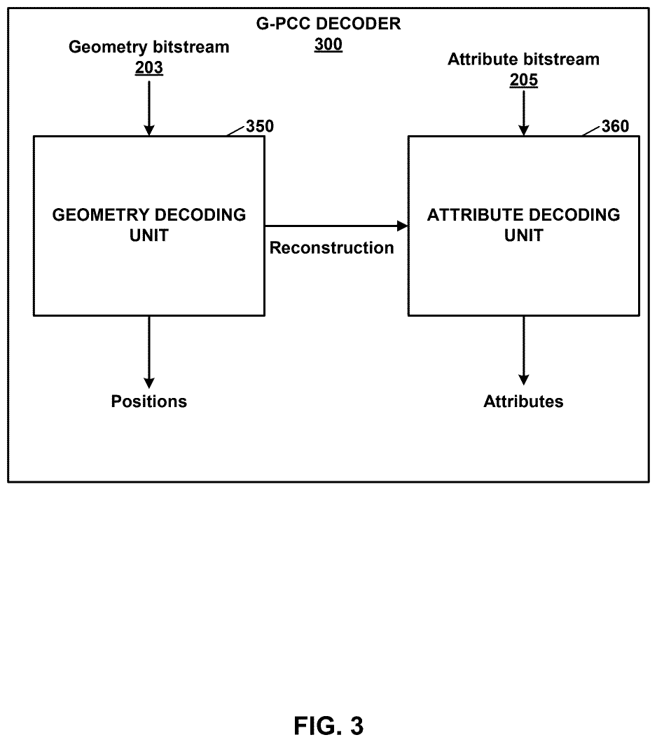

FIG. 2 provides an overview of G-PCC encoder 200. FIG. 3 provides an overview of G-PCC decoder 300. The modules shown are logical, and do not necessarily correspond one-to-one to implemented code. In the example of FIG. 2, G-PCC encoder 200 may include a geometry encoding unit 250 and an attribute encoding unit 260. In general, geometry encoding unit 250 is configured to encode the positions of points in the point cloud frame to produce geometry bitstream 203. Attribute encoding unit 260 is configured to encode the attributes of the points of the point cloud frame to produce attribute bitstream 205. As will be explained below, attribute encoding unit 260 may also use the positions, as well as the encoded geometry (e.g., the reconstruction) from geometry encoding unit 250 to encode the attributes.

In the example of FIG. 3, G-PCC decoder 300 may include a geometry decoding unit 350 and an attribute decoding unit 360. In general, geometry decoding unit 350 is configured to decode the geometry bitstream 203 to recover the positions of points in the point cloud frame. Attribute decoding unit 360 is configured to decode the attribute bitstream 205 to recover the attributes of the points of the point cloud frame. As will be explained below, attribute decoding unit 360 may also use the positions from the decoded geometry (e.g., the reconstruction) from geometry decoding unit 350 to encode the attributes.

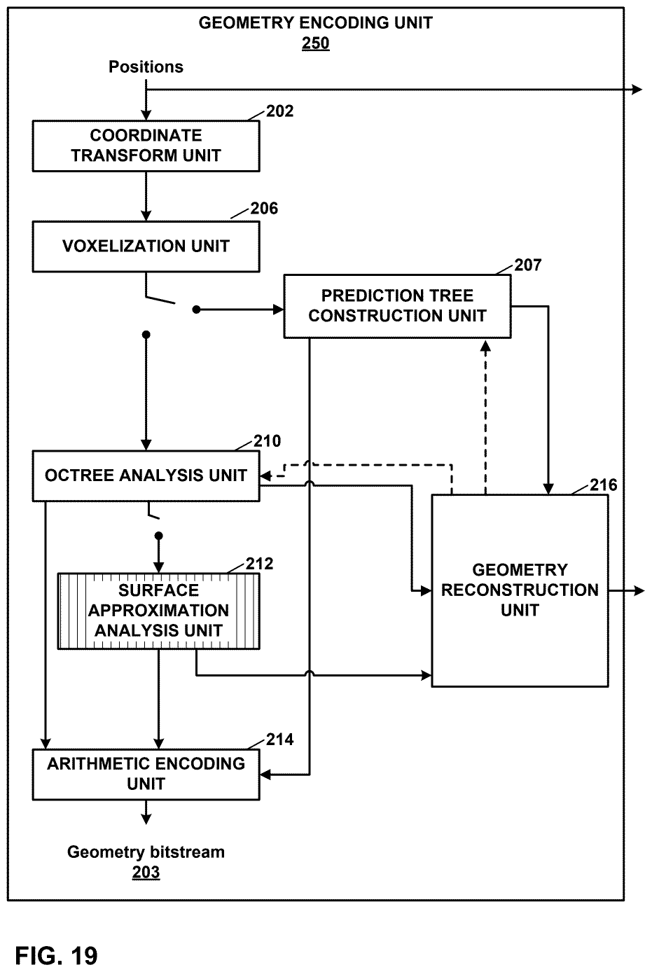

In both G-PCC encoder 200 and G-PCC decoder 300, point cloud positions are coded first. Attribute coding depends on the decoded geometry. In FIGS. 19-22 of this disclosure, the coding units with vertical hashing are options typically used for Category 1 data. Diagonal-crosshatched coding units are options typically used for Category 3 data. All the other modules are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

At each node of an octree, an occupancy is signaled (when not inferred) for one or more of its child nodes (up to eight nodes). Multiple neighborhoods are specified including (a) nodes that share a face with a current octree node, (b) nodes that share a face, edge or a vertex with the current octree node, etc. Within each neighborhood, the occupancy of a node and/or its children may be used to predict the occupancy of the current node or its children. For points that are sparsely populated in certain nodes of the octree, the codec also supports a direct coding mode where the 3D position of the point is encoded directly. A flag may be signaled to indicate that a direct mode is signaled. At the lowest level, the number of points associated with the octree node/leaf node may also be coded.

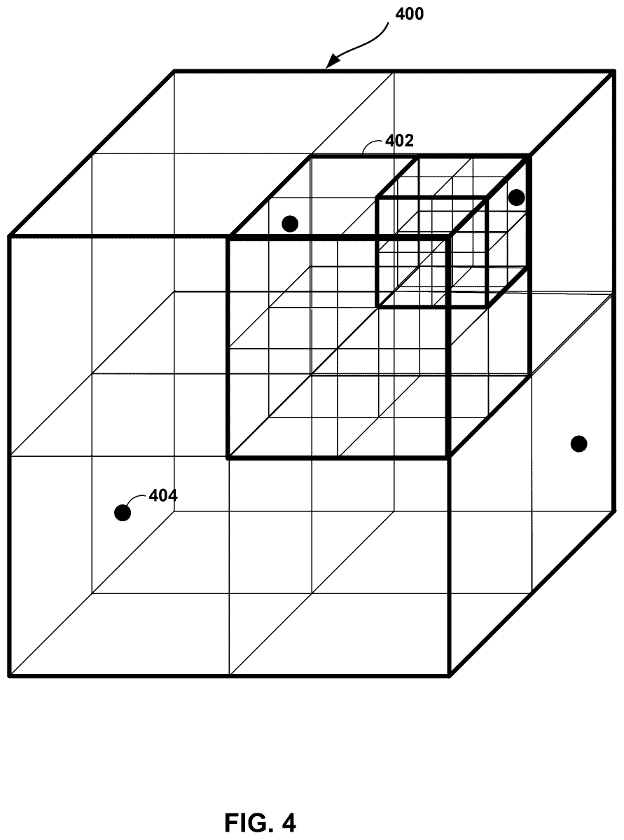

FIG. 4 is a conceptual diagram illustrating an example octree split for geometry coding. A node 400 represents a volumetric region within a 3D space, such as a bounding box or a non-leaf node of an octree. Partitioning of node 400 results in eight equal-sized sub-nodes or octants, such as sub-node 402.

Points 404 represent physical content or geometry positions within the 3D space. G-PCC encoder 200 or G-PCC decoder 300 utilizes an occupancy status to indicate whether a specific sub-node contains one or more of points 404. For example, sub-node 402 contains points and implies an occupied status. Conversely, sub-nodes containing no points imply an unoccupied status.

The coding process recursively subdivides occupied nodes until reaching a predetermined leaf level, such as a voxel level, or until meeting a termination condition. Empty nodes do not require further subdivision. This hierarchical structure allows G-PCC encoder 200 to signal geometry positions efficiently by indicating occupancy for child nodes at each level of the octree.

Once the geometry is coded, the attributes corresponding to the geometry points are coded. When there are multiple attribute points corresponding to one reconstructed/decoded geometry point, an attribute value may be derived that is representative of the reconstructed point.

There are three attribute coding methods in G-PCC: Region Adaptive Hierarchical Transform (RAHT) coding, interpolation-based hierarchical nearest-neighbor prediction (Predicting Transform), and interpolation-based hierarchical nearest-neighbor prediction with an update/lifting step (Lifting Transform). RAHT and Lifting are typically used for Category 1 data, while Predicting is typically used for Category 3 data. However, either method may be used for any data, and, just like with the geometry codecs in G-PCC, the attribute coding method used to code the point cloud is specified in the bitstream.

The coding of the attributes may be conducted in a level-of-detail (LoD), where with each level of detail a finer representation of the point cloud attribute may be obtained. Each level of detail may be specified based on distance metric from the neighboring nodes or based on a sampling distance.

At G-PCC encoder 200, the residuals obtained as the output of the coding methods for the attributes are quantized. The residuals may be obtained by subtracting the attribute value from a prediction that is derived based on the points in the neighborhood of the current point and based on the attribute values of points encoded previously. The quantized residuals may be coded using context adaptive arithmetic coding.

G-PCC encoder 200 and G-PCC decoder 300 may be configured to code point cloud data using predictive geometry coding as an alternative to the octree geometry coding. In prediction tree coding, the nodes of the point cloud are arranged in a tree structure (which defines the prediction structure), and various prediction strategies are used to predict the coordinates of each node in the tree with respect to its predictors. A node that is the root vertex has no predictors. Other nodes may have 1, 2, 3 or more children. Other nodes may be leaf nodes that have no children. In one example, every node of the predictive tree has only one parent node.

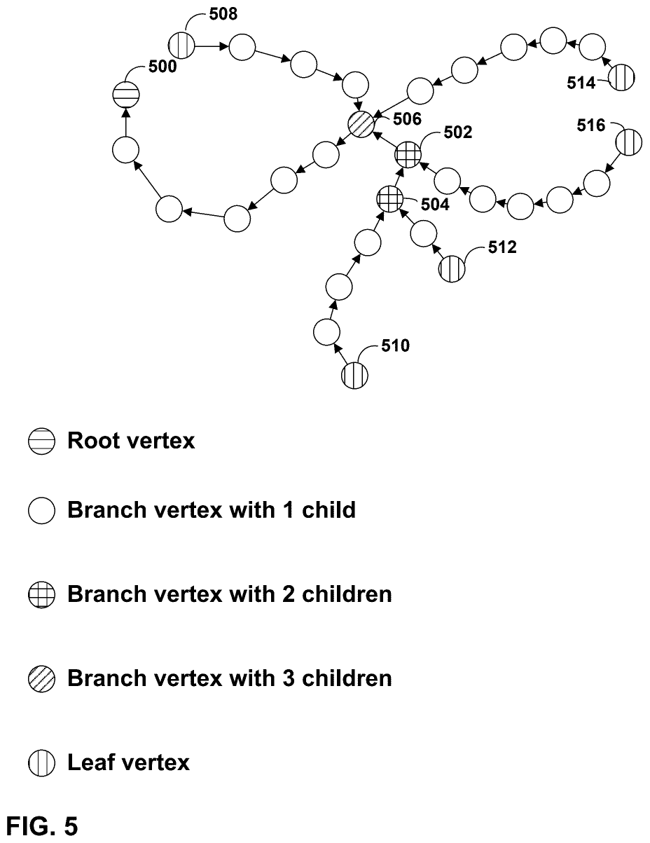

FIG. 5 is a conceptual diagram illustrating an example of a prediction tree, in accordance with one or more techniques of this disclosure. Node 500 is the root vertex and has no predictors. Nodes 502 and 504 have two children. Node 506 has 3 children.

Nodes 508, 510, 512, 514, and 516 are leaf nodes and these have no children. The remaining nodes each have one child. Every node aside from root node 500 has only one parent node.

In one example, four prediction strategies are specified for each node based on its parent (p0), grand-parent (p1) and great-grand-parent (p2):
No prediction/zero prediction (0)
Delta prediction (p0)
Linear prediction (2*p0−p1)
Parallelogram prediction (p0+p1−p2)

G-PCC encoder 200 may employ any algorithm to generate the prediction tree; the algorithm used may be determined based on the application/use case and several strategies may be used. For each node, the residual coordinate values are coded in the bitstream starting from the root node in a depth-first manner. Predictive geometry coding may be particularly useful for Category 3 (LIDAR-acquired) point cloud data, e.g., for low-latency applications.

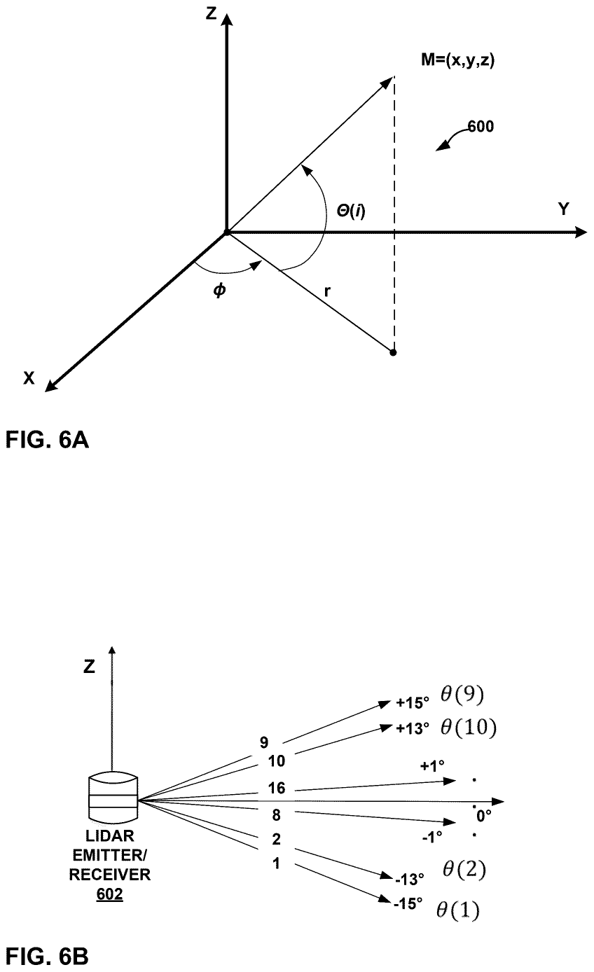

FIGS. 6A and 6B are conceptual diagrams illustrating an example of a spinning LIDAR acquisition model. LIDAR 602 may be used in automotive, mobile computing, aviation, and other scenarios. In some examples, angular mode may be used in predictive geometry coding, where the characteristics of LIDAR sensors may be utilized in coding the prediction tree more efficiently. The coordinates of the positions are converted to the (r, φ, i) (radius, azimuth and laser index) domain 600 and a prediction is performed in this domain 600 (the residuals are coded in r, φ, i domain). Due to the errors in rounding, coding in r, φ, i is not lossless and hence a second set of residuals are coded which correspond to the Cartesian coordinates. A description of the encoding and decoding strategies used for angular mode for predictive geometry coding is provided below.

Angular mode for predictive geometry coding may be used with point clouds acquired using a spinning LIDAR model. Here, the LIDAR 602 has N lasers (e.g., N=16, 32, 64) spinning around the Z axis according to an azimuth angle φ. Each laser may have different elevation θ(i)_{i=1 . . . N} and height [symbol] (i)_{i=1 . . . N}. In one example, laser i hits a point M, with cartesian integer coordinates (x, y, z), defined according to the coordinate system of an example spinning LIDAR acquisition model shown in FIGS. 6A-6B.

Angular mode for predictive geometry coding may include modelling the position of M with three parameters (r, φ, i), which are computed as follows:

$$r = \sqrt{{x}^{2} + {y}^{2}}$$

$$ϕ = a tan 2 ( y , x )$$

$$i = arg {min}_{j = 1 … N} \{ z + ς ( j ) - r \times tan ( θ ( j ) ) \} ,$$

More precisely, angular mode for predictive geometry coding uses the quantized version of (r, φ, i), denoted (\tilde{r}, \tilde{φ}, i), where the three integers \tilde{r}, \tilde{φ} and i are computed as follows:

$$∘ \tilde{r} = floor ( \frac{\sqrt{{x}^{2} + {y}^{2}}}{{q}_{r}} + {o}_{r} ) = hypot ( x , y )$$

$$∘ \tilde{ϕ} = sign ( a tan 2 ( y , x ) ) \times floor ( \frac{\vert a tan 2 ( y , x ) \vert}{{q}_{ϕ}} + {o}_{ϕ} )$$

$$∘ i = arg {min}_{j = 1 … N} \{ z + ς ( j ) - r \times tan ( θ ( j ) ) \}$$

where
(q_r, o_r) and {(q}_{φ}, o_{φ}) are quantization parameters controlling the precision of \tilde{φ} and \tilde{r}, respectively.
sign(t) is the function that return 1 if t is positive and (−1) otherwise.
   |t| is the absolute value of t.

To avoid reconstruction mismatches due to the use of floating-point operations, the values of [symbol] (i)_{i=1 . . . N} and tan(θ(i))_{i=1 . . . N} may be pre-computed and quantized as follows:

$$\tilde{z} ( i ) = sign ( ς ( i ) ) \times floor ( \frac{\vert ς ( i ) \vert}{{q}_{ς}} + {o}_{ς} )$$

$$t {}^{\sim} ( i ) = sign ( ς ( tan \text{?} ( θ ( j ) \text{?} ) ) \times floor ( \vert tan \text{?} θ ( j ) \text{?} \vert / q\_θ + o\_θ )$$

where
(q_ [symbol] , o_ [symbol] ) and [symbol] q [symbol] _{θ}, o_{θ}) are quantization parameters controlling the precision of [symbol] and \tilde{θ}, respectively.
The reconstructed cartesian coordinates are obtained as follows:

$$∘ \hat{x} = round ( \tilde{r} \times {q}_{r} \times {app}_{cos} ( \tilde{ϕ} + {q}_{ϕ} ) )$$

$$∘ \hat{y} = round ( \tilde{r} \times {q}_{r} \times {app}_{sin} ( \tilde{ϕ} + {q}_{ϕ} ) )$$

$$∘ \hat{z} = round ( \tilde{r} \times {q}_{r} \times \tilde{t} ( i ) \times {q}_{θ} - \tilde{z} ( i ) \times {q}_{ς} ) ,$$

where app_{cos}(⋅) and appₛᵢₙ(⋅) are approximation of cos(⋅) and sin(⋅). The calculations could be performed using a fixed-point representation, a look-up table, and linear interpolation.

Note that (\hat{x}, ŷ, \hat{z}) may be different from (x, y, z) due to various reasons:
quantization
approximations
model imprecision
model parameters imprecisions
Let (rₓ, r_{y}, r_{z}) be the reconstruction residuals defined as follows:

$$- {r}_{x} = x - \hat{x}$$

$$- {r}_{y} = y - \hat{y}$$

$$- {r}_{z} = z - \hat{z}$$

In this method, G-PCC encoder 200 may proceed as follows:
Encode the model parameters \tilde{t}(i) and \tilde{z}(i) and the quantization parameters qᵣq [symbol] , q_{θ}, and q_{φ}
Apply a geometry predictive scheme to the representation (\tilde{r}, \tilde{φ}, i)
   A new predictor leveraging the characteristics of LIDAR could be introduced. For instance, the rotation speed of the LIDAR scanner around the z-axis is usually constant. Therefore, G-PCC encoder 200 may predict the current \tilde{φ}(j) as follows:

$$\tilde{ϕ} ( j ) = \tilde{ϕ} ( j - 1 ) + n ( j ) \times {δ}_{ϕ} ( k )$$

Where
   (δ_{φ}(k))_{k=1 . . . K} is a set of potential speeds the encoder could choose from. The index k could be explicitly written to the bitstream or could be inferred from the context based on a deterministic strategy applied by both G-PCC encoder 200 and G-PCC decoder 300, and
   n(j) is the number of skipped points which may be explicitly written to the bitstream or may be inferred from the context based on a deterministic strategy applied by both the encoder and the decoder. It is also referred to as “phi multiplier” later. Note, it is currently used only with delta predictor.
Encode with each node the reconstruction residuals (rₓ, r_{y}, r_{z}).

G-PCC decoder 300 may proceed as follows:
Decodes the model parameters \tilde{t}(i) and \tilde{z}(i) and the quantization parameters qᵣq [symbol] , q_{θ} and q_{φ}
Decodes the (\tilde{r}, \tilde{φ}, i) parameters associated with the nodes according to the geometry predictive scheme described in [1]
Computes the reconstructed coordinates (\hat{x}, ŷ, \hat{z}) as described above
Decodes the residuals (rₓ, r_{y}, r_{z})
   As discussed in the next section, lossy compression could be supported by quantizing the reconstruction residuals (rₓ, r_{y}, r_{z})
Compute the original coordinates (x, y, z) as follows

$$∘ x = {r}_{x} + \hat{x}$$

$$∘ y = {r}_{y} + \hat{y}$$

$$∘ z = {r}_{z} + \hat{z}$$

Lossy compression may be achieved by applying quantization to the reconstruction residuals (rₓ, r_{y}, r_{z}) or by dropping points. The quantized reconstruction residuals may be computed as follows:

$$∘ {\tilde{r}}_{x} = sign ( {r}_{x} ) \times floor ( \frac{\vert {r}_{x} \vert}{{q}_{x}} + {o}_{x} )$$

$$∘ {\tilde{r}}_{y} = sign ( {r}_{y} ) \times floor ( \frac{\vert {r}_{y} \vert}{{q}_{y}} + {o}_{y} )$$

$$∘ {\tilde{r}}_{z} = sign ( {r}_{z} ) \times floor ( \frac{\vert {r}_{z} \vert}{{q}_{z}} + {o}_{z} )$$

Where (qₓ, oₓ), (q_{y}, o_{y}) and (q_{z}, o_{z}) are quantization parameters controlling the precision of \tilde{r}ₓ, \tilde{r}_{y} and \tilde{r}_{z}, respectively.

Trellis quantization may be used to further improve the RD (rate-distortion) performance results. The quantization parameters may change at sequence/frame/slice/block level to achieve region adaptive quality and for rate control purposes.

The attribute coding, octree geometry coding, and predictive tree geometry coding techniques may be performed as intra prediction coding techniques. That is, G-PCC encoder 200 and G-PCC decoder 300 may code attribute and position data using only information from the frame of point cloud data being coded. In other examples, G-PCC encoder 200 and G-PCC decoder 300 may encode and decode attributes, octree geometry, and/or predictive tree geometry using inter prediction techniques. That is, G-PCC encoder 200 and G-PCC decoder 300 may code attribute and position data using information from the frame of point cloud data being coded as well as information from previously-coded frames of point cloud data.

As described above, one example of predictive geometry coding uses a prediction tree structure to predict the positions of the points. When angular coding is enabled, the x, y, z coordinates are transformed to radius, azimuth and laserID and residuals are signaled in these three coordinates as well as in the x, y, z dimensions. The intra prediction used for radius, azimuth and laserID may be one of four modes and the predictors are the nodes that are classified as parent, grand-parent and great-grandparent in the prediction tree with respect to the current node. In one example, predictive geometry coding may be configured as an intra coding tool as it only uses points in the same frame for prediction. However, using points from previously-decoded frames (e.g., inter-prediction) may provide a better prediction and thus better compression performance in some circumstances.

For predictive geometry coding using inter prediction, one technique involves predicting the radius of a point from a reference frame. For each point in the prediction tree, it is determined whether the point is inter predicted or intra predicted (indicated by a flag). When intra predicted, the intra prediction modes of predictive geometry coding are used. When inter-prediction is used, the azimuth and laserID are still predicted with intra prediction, while the radius is predicted from the point in the reference frame that has the same laserID as the current point and an azimuth that is closest to the current azimuth. Another example of this method enables inter prediction of the azimuth and laserID in addition to radius prediction. When inter-coding is applied, the radius, azimuth and laserID of the current point are predicted based on a point that is near the azimuth position of a previously decoded point in the reference frame. In addition, separate sets of contexts are used for inter and intra prediction.

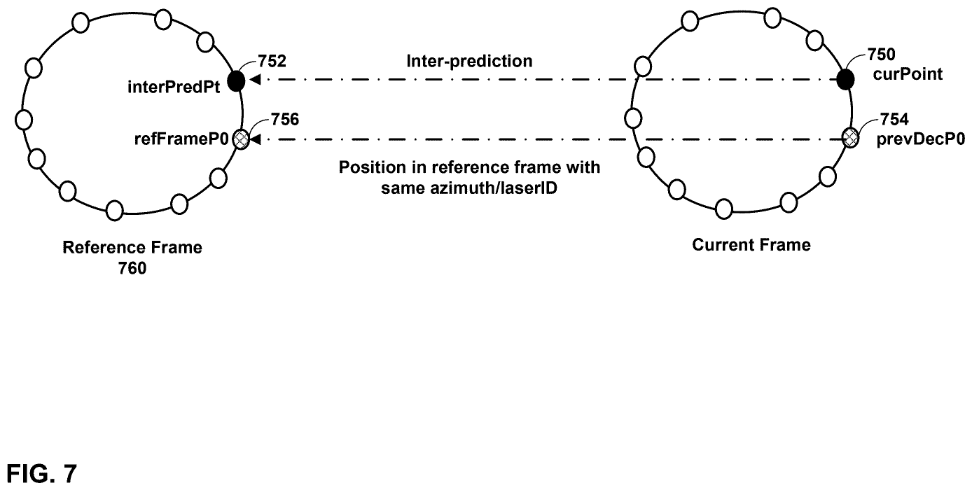

FIG. 7 is a conceptual diagram illustrating an example of inter-prediction of a current point (curPoint) 750 in a current frame from a point (interPredPt) 752 in the reference frame. The extension of inter prediction to azimuth, radius, and laserID may include the following steps:
For a given point, choose the previous decoded point (prevDecPO) 754.
Choose a position point (refFramePO) 756 in the reference frame that has same scaled azimuth and laserID as prevDecPO 754.
In the reference frame, find the first point (interPredPt) 752 that has azimuth greater than that of refFramePO 756. The point interPredPt 752 may also be referred to as the “Next” inter predictor.

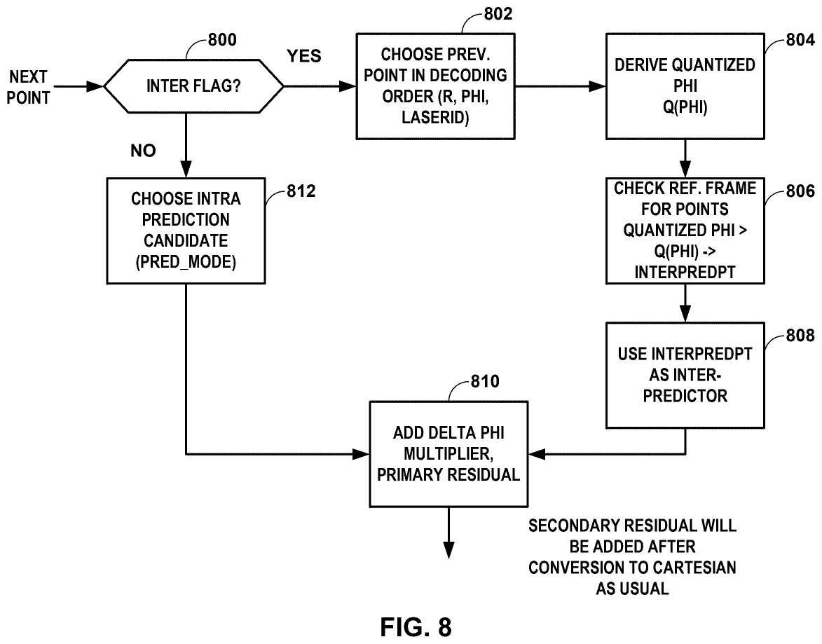

FIG. 8 is a flow diagram illustrating example operation of a G-PCC decoder. FIG. 8 illustrates the decoding flow associated with the “inter_flag” that is signaled for every point. The technique is available in InterEM-v3.0.

For example, G-PCC decoder 300 may determine whether the inter flag is true (e.g., equal to 1) (800). If the inter flag is true (the “YES” path from block 800), G-PCC decoder 300 may choose a previous decoded point in decoding order using radius, azimuth, and laserID (802). G-PCC decoder 300 may derive a quantized phi, Q(phi) (e.g., a quantized value of the azimuth) of the chosen previous decoded point (e.g., prevDecPO 754) (804). G-PCC decoder 300 may check the reference frame (e.g., reference frame 760 of FIG. 7) for points where the quantized phi of such points is greater than Q(phi) which may lead to interPredPt 752 (806). G-PCC decoder 300 may then use interPredPt 752 as an inter-predictor for the current point, curPoint 750 (808). G-PCC decoder 300 may then add a delta phi multiplier, e.g., n(j)×δ_{φ}(k) as discussed above, to the primary residual (810).

If the inter flag is false (e.g., is equal to 0) (the “NO” path from block 800), G-PCC decoder 300 may choose an intra prediction candidate (812) and apply intra prediction. G-PCC decoder 300 may then add a delta phi multiplier to yield the primary residual (810).

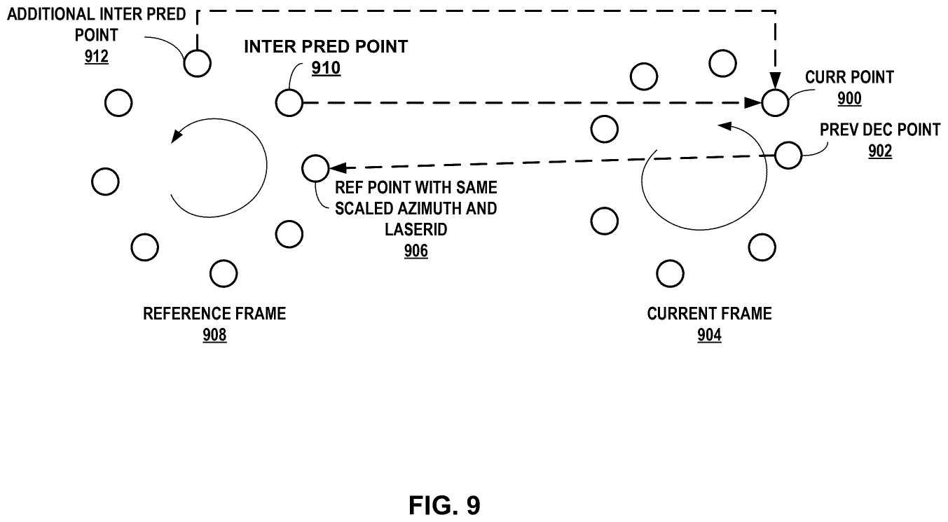

FIG. 9 is a conceptual diagram illustrating an example of an additional inter predictor point obtained from the first point that has an azimuth greater than the inter predictor point. An additional predictor candidate is now discussed. Information relating to the additional predictor candidate may be found in K. L. Loi, T. Nishi, T. Sugio, [G-PCC][New] Inter Prediction for Improved Quantization of Azimuthal Angle in Predictive Geometry Coding, ISO/IEC JTC1/SC29/WG7 m57351, July 2021. In the inter prediction technique for predictive geometry described above, the radius, azimuth, and laserID of the current point are predicted based on a point that is near the collocated azimuth position in the reference frame when inter coding is applied, for example, by G-PCC decoder 300, using the following steps:
1) for a given point (e.g., a current point, Curr Point 900), choose the previous decoded point (e.g., Prev Dec Point 902) of current frame 904,
2) choose a position (e.g., Ref Point 906) in reference frame 908 that has the same scaled azimuth and laserID as the previous decoded point (e.g., Prev Dec Point 902),
3) choose a position (Inter Pred Point 910) in reference frame 908 from the first point that has azimuth greater than the position in reference frame 908 that has the same scaled azimuth and laserID as the previous decoded point (e.g., Prev Dec Point 902), to be used as the inter predictor point.

This technique adds an additional inter predictor point 912 that is obtained by finding the first point that has an azimuth greater than the inter predictor point (e.g., Inter Pred Point 910) as shown in FIG. 9. Additional signaling is used to indicate which of the predictors is selected if inter coding has been applied by G-PCC encoder 200. For example, G-PCC encoder 200 may signal to G-PCC decoder 300 which of the predictors is selected. The additional inter predictor point may also be referred to as the “NextNext” inter predictor.

Inter prediction flag coding is now discussed. Information regarding such inter prediction flag coding may be found in A. K. Ramasubramonian, L. Pham Van, G. Van der Auwera, M. Karczewicz, [G-PCC][New proposal] Improvements to inter prediction using predictive geometry coding, ISO/IEC JTC1/SC29/WG7 m57299, July 2021. A context selection algorithm may be applied for coding the inter prediction flag. G-PCC encoder 200 may use the inter prediction flag values of the five previously coded points to select the context of the inter prediction flag in predictive geometry coding.

Global motion compensation is now described. When global motion (GM) parameters are available, inter prediction may be applied using a reference frame that is motion compensated using the GM parameters, as described in A. K. Ramasubramonian, G. Van der Auwera, L. Pham Van, M. Karczewicz, [G-PCC][New proposal] Results on inter prediction for predictive geometry coding, ISO/IEC JTC1/SC29/WG7 m59650, April 2022. The GM parameters may include rotation parameters and/or translation parameters. Typically, G-PCC encoder 200 or G-PCC decoder 300 may apply global motion compensation in the Cartesian domain. In some cases, G-PCC encoder 200 or G-PCC decoder 300 may apply global motion compensation in the spherical domain. Depending on which domain the reference frame is stored, and which domain the reference frame is compensated, one or more of Cartesian to spherical domain conversion techniques, or spherical to Cartesian domain conversion techniques may be applied, for example, by G-PCC encoder 200 or G-PCC decoder 300.

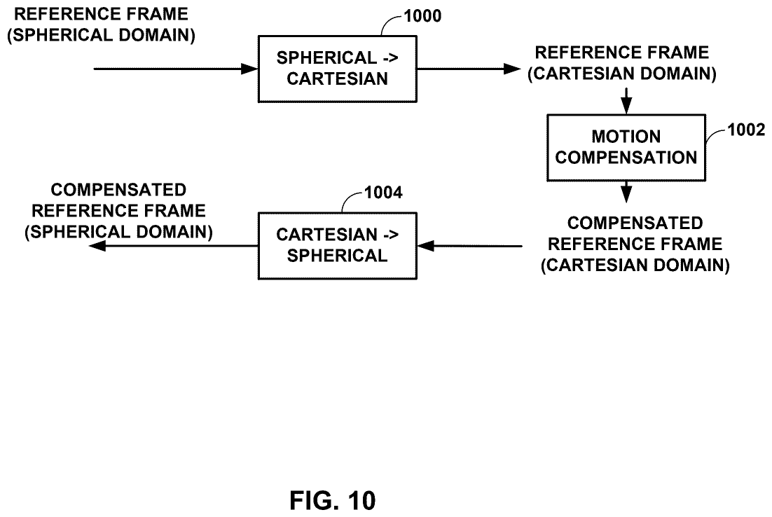

FIG. 10 is a flow diagram illustrating an example of motion compensation techniques where the reference frame is in the spherical domain and the motion compensation is applied in the Cartesian domain. For example, when the reference frame is stored in spherical domain, and the motion compensation is performed in the Cartesian domain, the motion compensation process may involve one or more of the steps shown in FIG. 10. In such cases, the compensated reference frame may be used for inter prediction.

For example, G-PCC encoder 200 or G-PCC decoder 300 may convert a reference frame from the spherical domain to the Cartesian domain (1000). G-PCC encoder 200 or G-PCC decoder 300 may apply motion compensation to the converted reference frame in the Cartesian domain (1002). G-PCC encoder 200 or G-PCC decoder 300 may convert the compensated reference frame from the Cartesian domain to the spherical domain (1004).

For example, given a position (x, y, z) in the Cartesian coordinate system, the corresponding radius and azimuthal angle may be calculated (e.g., using a floating point implementation) as follows (As a CartesianToSpherical conversion function):

$$int64\_t r 0 = int64\_t ( std \text{::} round ( hypot ( xyz [ 0 ] , xyz [ 1 ] ) ) ) ;$$

$$auto phi 0 = std \text{::} round ( ( a tan 2 ( xyz [ 1 ] , xyz [ 0 ] ) / ( 2. * M\_PI ) ) * scalePhi ) ;$$

where, scalePhi is modified for different rate points in a lossy configuration; a maximum value of 24 bits is used for azimuth angle when coding the geometry losslessly. The fixed-point implementation of the azimuth is available in a convertXyZToRpl function.

### Radius:

| | |
|---|---|
| Floating | int64_t r0 = int64_t(std::round(hypot(xyz[0], |
| implementation | xyz[1]))); |
| Fixed point | int64_t xLaser = xyz[0] << 8; |
| implementation | int64_t yLaser = xyz[1] << 8; |
| (in convertXyzToRpl) | int64_t r0 = isqrt(xLaser * xLaser + yLaser * |
| | yLaser) >> 8; |

| | |
|---|---|
| Floating | auto phi0 = std::round((atan2(xyz[1], xyz[0])/ |
| implementation | (2.0 * M_PI)) * scalePhi); |
| Fixed point | (*dst)[1] = (iatan2(yLaser, xLaser) + |
| implementation | 3294199) >> 8; |
| (in convertXyzToRpl) | |

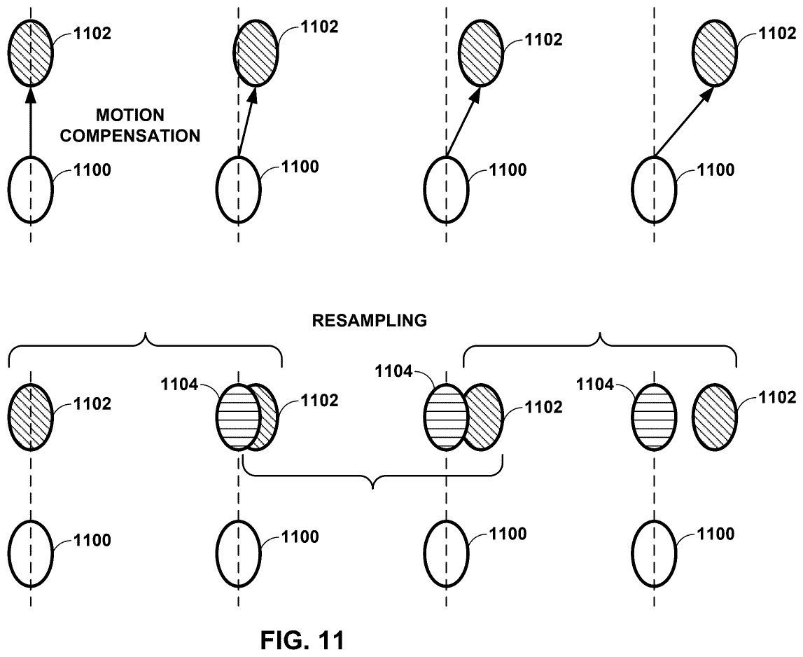

Resampling of a reference frame is now discussed. FIG. 11 is a conceptual diagram illustrating an example of azimuth resampling of motion compensated references. When global motion compensation is applied, the azimuth position of the points of the reference frame are modified depending on the motion parameters.

Therefore, resampling may be needed or desired to align the azimuth points before and after compensation as illustrated in FIG. 11. The non-filled ovals represent points 1100 in an uncompensated reference frame (e.g., a reference frame without, or prior to, any global motion compensation being applied). The diagonal-line-filled ovals represent points 1102 in a global motion compensated version of the reference frame. The horizontal-line-filled ovals represent resampled points 1104 of the global motion compensated version of the reference frame. Thus, points 1100 have no global motion compensation applied, points 1102 have global motion compensation applied, and points 1104 have global motion compensation and resampling applied. As can be seen, the application of global motion compensation may cause the azimuth position of one or more of points 1102 to become misaligned with respective points of points 1100. By resampling, G-PCC encoder 200 or G-PCC decoder 300 may realign points 1102 (e.g., shown as resampled points 1104) with their respective points 1100.

G-PCC encoder 200 or G-PCC decoder 300 may apply the resampling process for each point P in the uncompensated reference frame (e.g., for each of points 1100) as follows: A_ref is the azimuth value and L be the laser ID value associated with the point P.
If there is a point P1 (e.g., a point of points 1102) in the global-motion-compensated reference frame, which may also be referred to as a compensated reference frame, that has azimuth value equal to A_ref and laser ID equal to L, the radius of the point P is set equal to the radius of point P1, for example if G-PCC encoder 200 or G-PCC decoder 300 use a same buffer for storing the uncompensated reference frame as for storing a resampled reference frame.

Else, two points P2 and P3 are chosen in the global-motion-compensated reference frame with laser ID L such that azimuth of P2 is less than A_ref, azimuth of P3 is greater than A_ref. The radius of point P is set equal to a weighted interpolation of radii of points P2 and P3; the weights used for the interpolation is dependent on the difference between A_ref and the azimuth values of P2 and P3.

The resultant reference frame (obtained by resampling the motion compensated reference frame using azimuth values from the uncompensated reference frame), referred to as the resampled reference frame, may be used to predict the inter prediction candidates. For example, G-PCC encoder 200 or G-PCC decoder 300 may use the resampled reference frame to predict the inter prediction candidates. The two inter predictor candidates may therefore be indicated as [Res-Next, Res-NextNext], where the first part “Res” indicates that the candidates are obtained from the resampled reference frame and the second part “Next”/“NextNext” indicate the particular candidate in the reference frame (as mentioned above).

A modified inter predictor with four inter prediction candidates may be specified as follows:
[Zero-Next, Zero-NextNext, Glob-Next, Glob-NextNext]

Here, the prefix “Zero” for the first two candidates indicates that the candidates are obtained directly from uncompensated reference frame (no motion compensation or resampling) and the prefix “Glob” for the last two candidates indicates that the candidates are obtained directly from global-motion-compensated reference frame.

G-PCC encoder 200 may send, and G-PCC decoder 300 may receive, a flag for signaling resampling (gm) to indicate 2/4 candidate. A flag was enabled to indicate whether resampling is enabled or not. Moreover, when global motion was disabled for the sequence, only two inter prediction candidates were allowed. Thus, the inter prediction candidates for predictive geometry coding were chosen as follows:
Global motion disabled:
   [Zero-Next, Zero-NextNext]
Global motion enabled
   Resampling enabled
      [Res-Next, Res-NextNext, Glob-Next, Glob-NextNext]
   Resampling disabled
      [Zero-Next, Zero-NextNext, Glob-Next, Glob-NextNext]

Here, the prefix “Res” for the first two candidates when both global motion and resampling is enabled indicates that the candidates are obtained from resampled reference frame.

Spherical coordinate conversion is now discussed. Spherical coordinate conversion is a technique used in G-PCC where geometry represented in the spherical coordinate system is used during attribute coding. Attribute coding typically involves the generation of levels of detail (for predicting/lifting transform), or generation RAHT tree (for RAHT transform), and both these processes make use of the geometry. When spherical coordinate conversion is not used, the geometry represented in Cartesian coordinates is used for attribute coding; a Morton scan order is chosen for parsing the points. For sparse data, such as those obtained using LIDAR sensors, using the Cartesian coordinates results in sub-optimal relationship of points in the Morton order. As the spherical coordinate system uses the sensor scan characteristics, geometry converted to the spherical coordinate system provides a much more efficient representation of the points. Morton scan order in this domain provides more meaningful relationship of points, and this improves the efficiency of coding attributes. Typically, spherical coordinate conversion is used only when the angular mode (used to code the geometry) is enabled.

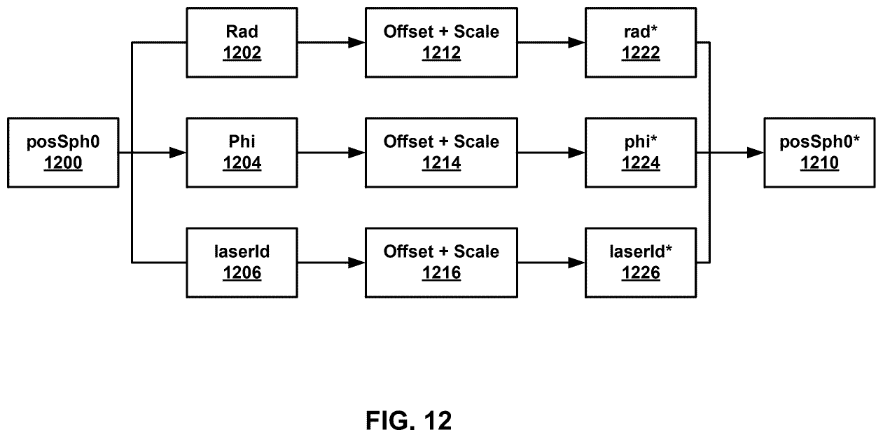

The spherical coordinate representation that is used is for attribute coding (posSph0*) is obtained by applying an offset and scale to the actual spherical coordinate representation of the geometry (posSph0). Applying offset/scale may be a linear transformation. FIG. 12 is a flow diagram illustrating an example of spherical coordinate conversion according to one or more aspects of this disclosure. FIG. 12 illustrates how the radius (rad), azimuth (phi) and laser ID (laserID) that together form the spherical representation posSph0 are transformed to rad*, phi* and laserID* of the spherical representation posSph0* that is used for attribute prediction. The offset and scale values for each dimension is signaled in the attribute parameter set (APS).

For example, G-PCC encoder 200 or G-PCC decoder 300 may obtain posSph0 1200. G-PCC encoder 200 or G-PCC decoder 300 may thereby obtain the components of posSph0 1200, namely rad 1202, phi 1204, and laserID 1206. G-PCC encoder 200 or G-PCC decoder 300 may apply an offset and scale 1212 to rad 1202 to generate rad* 1222. G-PCC encoder 200 or G-PCC decoder 300 may apply an offset and scale 1214 to phi 1204 to generate phi* 1224. G-PCC encoder 200 or G-PCC decoder 300 may apply an offset and scale 1216 to laserID 1206 to generate laserID* 1226. G-PCC encoder 200 or G-PCC decoder 300 may, from components rad* 1222, phi* 1224, and laserID* 1226 generate posSph0* 1210.

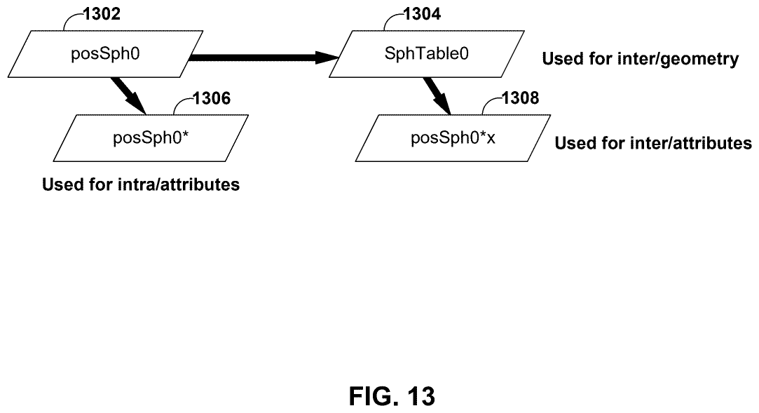

G-PCC encoder 200 and G-PCC decoder 300 may be configured to include an inter prediction buffer. The current software and specification use the same reference frame buffer for inter prediction of geometry and for inter prediction of attributes. The contents of the two buffers are not identical. For example with reference to FIG. 13, consider a reference frame 0. The reconstructed spherical coordinates of frame 0, posSph0 is used to generate posSph0* using spherical coordinate conversion as discussed above. This representation, posSph0* is used both for intra attribute prediction.

FIG. 13 is a conceptual diagram illustrating an example process for generating prediction buffers for point cloud compression. The process utilizes a set of reconstructed spherical coordinates of a reference frame, denoted as posSph0 1302.

As shown in FIG. 13, the process generates a modified spherical representation, denoted as posSph0* 1306, from posSph0 1302. A spherical coordinate conversion operation transforms posSph0 1302 to yield posSph0* 1306. An attribute decoder uses posSph0* 1306 for intra attribute prediction.

In parallel with the generation of posSph0* 1306, the process utilizes posSph0 1302 to generate a spherical table, denoted as SphTable0 1304. SphTable0 1304 supports inter prediction of geometry. SphTable0 1304 stores points in spherical coordinates indexed by quantization parameters.

The process further derives a scaled representation, denoted as posSph0x 1308. The process generates posSph0x 1308 based on the spherical representation stored in SphTable0 1304, partly using spherical coordinate conversion. The attribute decoder uses posSph0x 1308 for inter attribute prediction. Consequently, the buffer content used for intra attribute prediction (posSph0 1306) differs from the buffer content used for inter attribute prediction (posSph0x 1308), and the buffer content used for inter geometry prediction (SphTable0 1304) differs from the buffer content used for inter attribute prediction (posSph0x 1308).

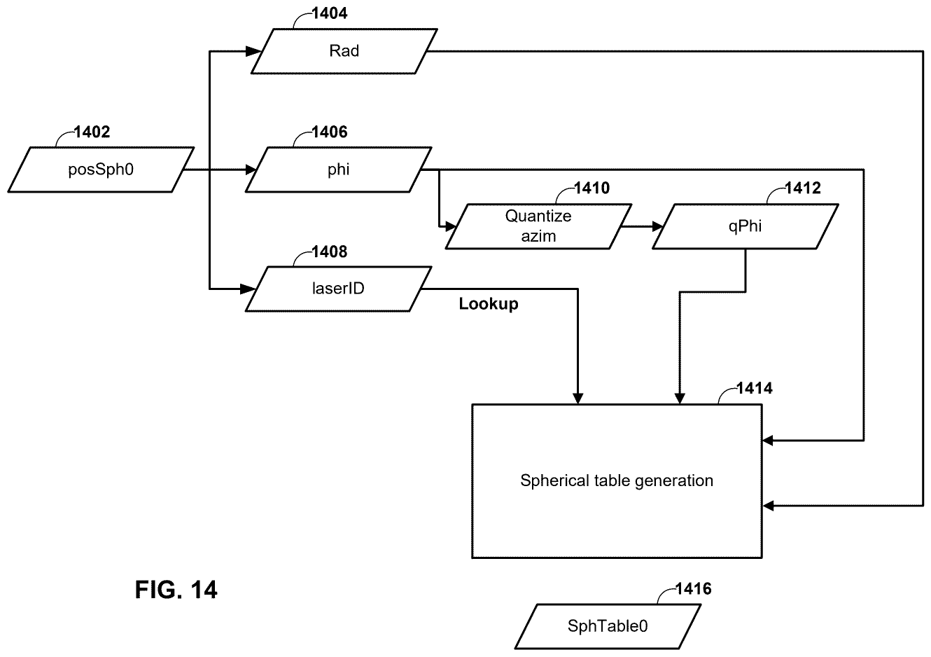

In parallel, with reference to FIG. 14, posSph0 is also used to generate a spherical table SphTable0 that is used for inter prediction of geometry by the following process. A quantized azimuth qPhi and laserID are used as lookup values in a spherical table that stores the points in the spherical coordinates. The spherical representation is then used to derive scaled presentation posSph0*x partly using spherical coordinate conversion. In addition, for each entry in the spherical table (indexed by a laser ID and quantized azimuth value), support of multiple points was added. Only the first point in each entry would be available for geometry inter prediction; but the other points would be available for attribute inter prediction. E.g., when points are added to the spherical table, multiple points in the reference frame may have the same quantized azimuth value and laser ID. A maxPointsPerEntryMinus1 syntax element provides a maximum number of points that may be added per entry of the spherical table. Until the maxPointsPerEntryMinus1+1 entries are not filled, points with same quantized azimuth and laser ID value are added to the entry. Below is an illustration of the spherical table with multiple points per entry (note that for each, the table associated with laser ID is depicted separately but in principle could be considered as a spherical table).

FIG. 14 is a conceptual diagram illustrating an example process for spherical table generation used in geometry inter prediction. The process utilizes a spherical representation of a point, denoted as posSph0 1402. posSph0 1402 comprises a radius component, Rad 1404, an azimuth component, phi 1406, and a laser identification component, laserID 1408.

As illustrated in FIG. 14, a quantization unit, Quantize azim 1410, receives phi 1406. Quantize azim 1410 quantizes phi 1406 to generate a quantized azimuth value, qPhi 1412. A spherical table generation process 1414 receives qPhi 1412 and laserID 1408. Spherical table generation process 1414 utilizes qPhi 1412 and laserID 1408 as lookup indices to organize entries within a spherical table, SphTable0 1416.

Simultaneously, spherical table generation process 1414 receives Rad 1404, phi 1406, and laserID 1408. Spherical table generation process 1414 stores Rad 1404, phi 1406, and laserID 1408 in SphTable0 1416 at a location determined by the lookup indices. SphTable0 1416 thereby stores points in spherical coordinates. G-PCC encoder 200 or G-PCC decoder 300 utilizes SphTable0 1416 for inter prediction of geometry.

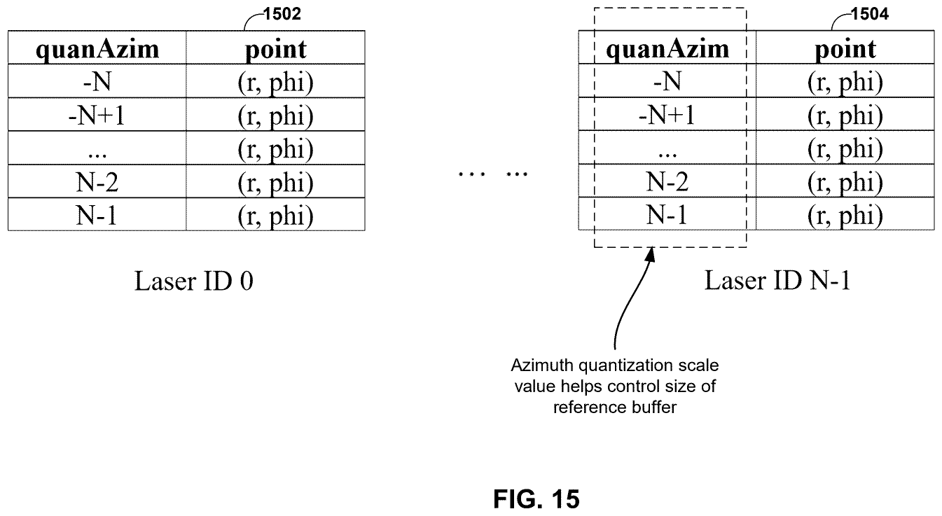

FIG. 15 is a conceptual diagram illustrating an example spherical table structure configured to store a single point per entry. G-PCC encoder 200 or G-PCC decoder 300 utilizes this structure to facilitate fast lookup of reference points during geometry inter prediction.

The spherical table structure organizes entries based on a quantized azimuth value, labeled as “quanAzim”. As shown in FIG. 15, the table structure maps a range of quantized azimuth indices (e.g., −N, −N+1, . . . , N−2, N−1) to corresponding point data. Each entry stores the spherical coordinates of a point, represented as a tuple comprising a radius and an azimuth angle (r, phi).

The structure segments data according to a laser identifier, creating distinct lookup regions for different lasers. As illustrated in FIG. 15, the data structure includes a spherical table 1502 associated with Laser ID 0 and a spherical table 1504 associated with Laser ID N−1. An azimuth quantization scale value determines the step size for the quantized azimuth indices, thereby controlling the overall size of the reference buffer. In this single-point-per-entry configuration, a lookup operation using a laser identifier and a quantized azimuth value retrieves a single predictor point (r, phi) for use in inter prediction.

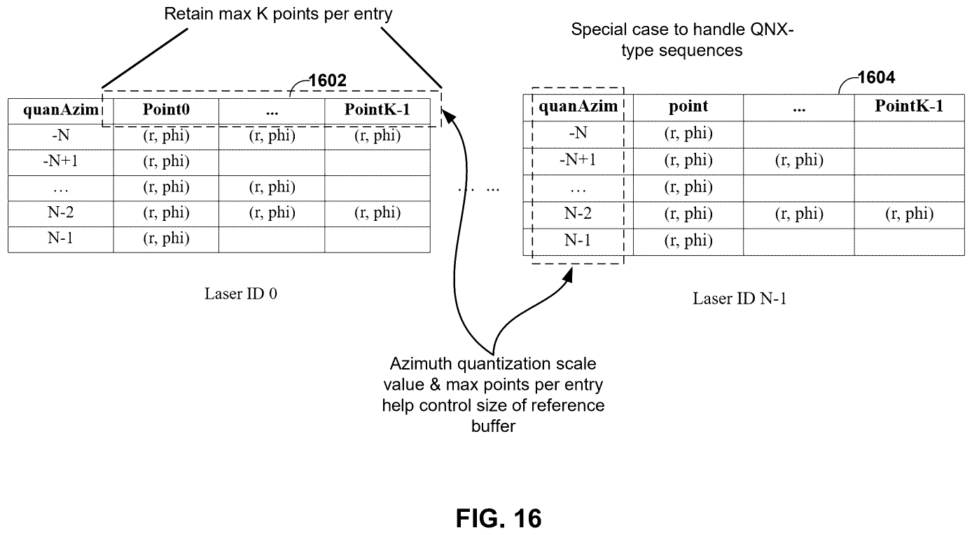

FIG. 16 is a conceptual diagram illustrating an example spherical table structure configured to store multiple points per entry. G-PCC encoder 200 or G-PCC decoder 300 utilizes this structure to enable the storage of multiple candidates for a single lookup index, thereby supporting scenarios where multiple points map to the same quantized location.

Similar to the single-point structure, the spherical table organizes entries based on a quantized azimuth value, “quanAzim”. The table maps quantized azimuth indices (e.g., −N, −N+1, . . . , N−2, N−1) to lists of point data. As shown in FIG. 16, each entry may store a list of up to K points, denoted as Point0 through Point K−1. Each point in the list is represented by its spherical coordinates (r, phi).

The structure segments data by laser identifier, including a spherical table 1602 associated with Laser ID 0 and a spherical table 1604 associated with Laser ID N−1. This configuration allows G-PCC encoder 200 or G-PCC decoder 300 to retain a maximum of K points per entry. Additionally, an azimuth quantization scale value and the maximum points per entry setting help control the size of the reference buffer. The structure may also support special cases to handle specific sequence types, such as QNX-type sequences.

The techniques of this disclosure address several potential problems. As an example of a first problem, a spherical table is used to represent the reference frame for inter prediction in predictive geometry coding. This spherical table enables (with hash or sorted indices) fast search of points during inter prediction candidate search. However, the current inter prediction schemes in predicting/lifting transforms and the RAHT transforms for attribute access the points in the reference frame in a linear fashion. Different processes that may be used to convert the spherical table to linear array (or processes that define a linear access to the spherical table) may result in different order of points presented to the attribute transforms. Without specifying a particular process, different decoders may output different point cloud sequences which would make definition of conformance impractical.

Generally, the points are added in the spherical table starting from a linear buffer array (when the reference frame is decoded, the reference frame is typically stored in a linear buffer/array). Current TMC13 software uses the following mechanism to convert the spherical table to linear access.
Each laser ID in increasing order;
within the same laser ID, increasing values of quantized azimuth value (table look-up value) are accessed;
for each entry in the table (particular value of laser ID and quantized azimuth), if there are multiple points, then the points are accessed in the order in which the points were added to the buffer.

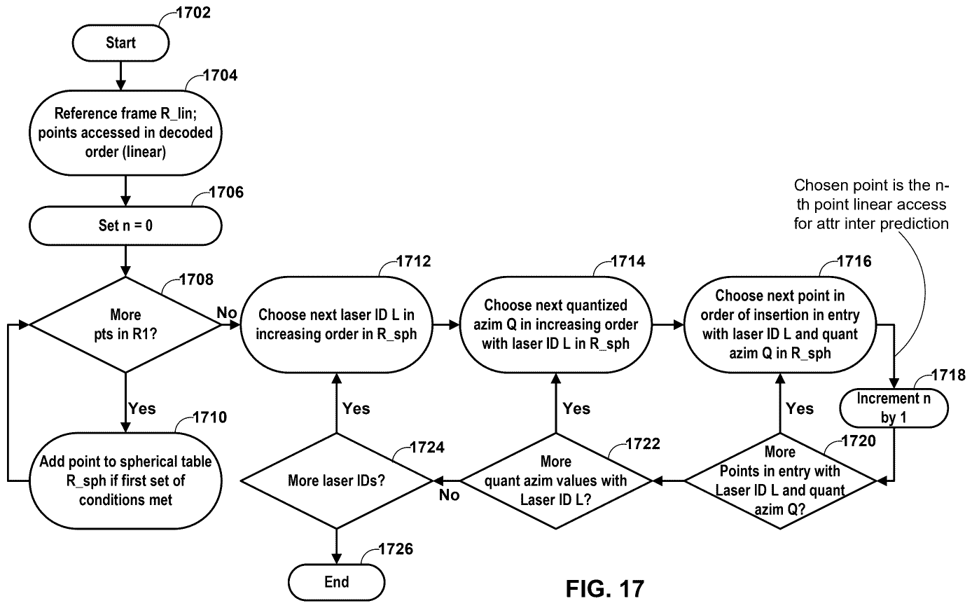

The above process to obtain the linear access of points in the reference frame starting from the decoded frame is referred to as the first process (illustrated in FIG. 17).

Spherical table generation inherently allows a downsampling mechanism (using the azimuth scale value) and hence the reference frame used for geometry and attributes may not include all the points that were decoded in the reference frame. By the first process, the relative order of points in the decoded buffer may be different from the order defined in the linear access (if point A occurs before point B in the decoded linear buffer, point A may occur after point B in the linear access). FIG. 17 shows the generation of the spherical table R_sph from the decoded reference frame in linear order R_lin. As depicted, the spherical table is first generated from all the points in the reference frame R_lin, and then the linear access is defined.

FIG. 17 is a flow diagram illustrating an example process for obtaining a linear access of points in a reference frame. The process begins (1702) by accessing a reference frame, denoted as R_lin, where points are accessed in a decoded order (linear) (1704).

The process sets a counter variable, n, to 0 (1706). The process determines whether there are more points in R1 (1708). If more points exist in R1 (YES path from 1708), the process adds a point to a spherical table, denoted as R_sph, if a first set of conditions are met (1710). The first set of conditions may include determining whether a number of points in an entry has exceeded a specified maximum number of points per entry.

If no more points exist in R1 (NO path from 1708), the process initiates a sequence of nested loops to define the linear access. The process chooses a next laser ID, L, in increasing order in R_sph (1712). The process chooses a next quantized azimuth, Q, in increasing order with laser ID L in R_sph (1714). The process chooses a next point in an order of insertion in an entry with laser ID L and quantized azimuth Q in R_sph (1716).

The chosen point becomes the n-th point in the linear access for attribute inter prediction. The process increments n by 1 (1718). The process determines whether more points exist in the entry with laser ID L and quantized azimuth Q (1720). If more points exist (YES path), the process returns to step 1716. If no more points exist (NO path), the process determines whether more quantized azimuth values exist with laser ID L (1722).

If more quantized azimuth values exist (YES path), the process returns to step 1714. If no more quantized azimuth values exist (NO path), the process determines whether more laser IDs exist (1724). If more laser IDs exist (YES path), the process returns to step 1712. If no more laser IDs exist (NO path), the process ends (1726).

As illustrated in FIG. 17, this process generates the spherical table R_sph from the points in the reference frame R_lin before defining the linear access. Consequently, a relative order of points in the decoded buffer may differ from a relative order of points in the linear access. Furthermore, because the process defines linear access based on laser ID and quantized azimuth rather than memory location, points that are successive in the linear access may not be located in nearby locations in memory, potentially increasing cache misses.

The first set of conditions to add points to the spherical table may include one or more of the following conditions:
points may be entered in an entry if the number of points in the entry has not exceeded a maximum number of points per entry that is specified.
In some cases, one or more of the radius, azimuth and attribute (e.g., reflectance) may be used to compare to the last added point in the entry to determine whether a point is to be added to the spherical table.

A potential downside of first process is that linear access of spherical table may not happen from adjacent locations in memory. E.g., based on the type of data structure and memory management used, points that are successive in the linear access presented to the attribute inter prediction may not be located in nearby locations in the memory. This may increase chances of cache misses which would increase the runtime. Even if the points in linear access are not re-written, the determination of the n-th point occurs in multiple passes of the spherical reference table. Moreover, the points may be re-written (or order redefined) even when no point is removed during the spherical table generation process. This can be computationally expensive. Moreover, even when points are downsampled, there is a benefit in keeping the relative order of the points as that helps in attribute inter prediction by accessing similar memory locations.

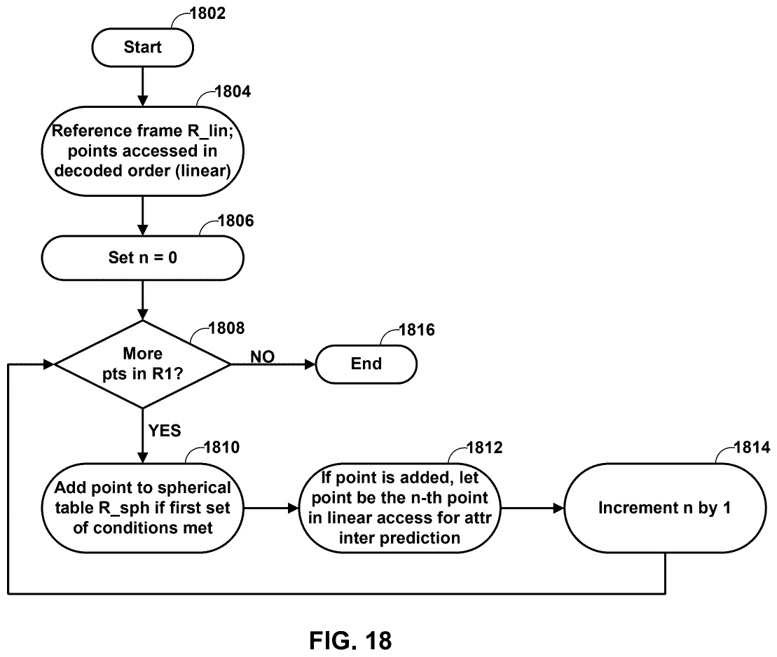

As an example of a potential solution to the first problem, the points in the reference frame are processed in the decoding order; for each point a determination is made whether the point will remain in the reference frame or be removed from the reference frame (e.g., as part of a downsampling process). Note that a first subset of the points that remain in the spherical reference table/reference frame may be used inter prediction of geometry and a second subset of the points that remain in the reference frame may be used for inter prediction of attributes (the first and second subsets may be same or different, and need not be mutually exclusive). If a point remains in the reference frame, then the point's index in the linear access is determined (value n in FIG. 18).

FIG. 18 is a flow diagram illustrating an example process for obtaining points in a reference frame according to techniques of this disclosure. The process ensures that a relative order of points in a decoded buffer matches a relative order of points in a linear access used for attribute inter prediction.

As shown in FIG. 18, the process starts (1802) by accessing a reference frame, denoted as R_lin. G-PCC encoder 200 or G-PCC decoder 300 accesses points within R_lin in a decoded order (linear) (1804). The process sets a counter variable, n, to 0 (1806).

The process determines whether more points exist in the reference frame, R1 (1808). If no more points exist in R1 (NO path from 1808), the process ends (1816). If more points exist in R1 (YES path from 1808), the process evaluates a current point against a first set of conditions. The process adds the current point to a spherical table, denoted as R_sph, if the first set of conditions are met (1810). This step effectively determines whether the point will remain in the reference frame or be removed, such as during a downsampling process.

If the process adds the point (or determines the point should remain), the process designates the point as the n-th point in a linear access for attribute inter prediction (1812). In some examples, the process stores the point in a linear buffer at the n-th index. This storage operation may involve overwriting the input reference frame R_lin. By storing the point at the n-th index based on the decoding order traversal, the process ensures that the relative order of the points in the decoding order remains unchanged in the linear access.

The process increments n by 1 (1814). The process then returns to determining whether more points exist in R1 (1808). By preserving the decoding order in the linear access buffer, the process ensures that points accessed sequentially during attribute inter prediction are more likely to reside in adjacent or nearby memory locations, thereby reducing cache misses and computational complexity.

In some examples, only points used in geometry inter prediction are explicitly added to the spherical reference table R_sph. Points in the reference frame used for attribute inter prediction but not for geometry inter prediction may be implicitly stored in the linear buffer without explicit addition to the spherical reference table.

In some examples, the points remaining in the reference frame that may be used for attribute inter prediction are stored in a linear buffer at the n-th index (this may be done by over-writing the input reference frame R_lin).

This way, the relative order of the points in the decoding order does not change in the linear access. Moreover, if no points are removed, the disclosed process would not result in any re-write of points thus have fewer computations, which typically results in less cache misses.

In one example, only points that are used in the geometry inter prediction are explicitly added in the spherical reference table; the points in the reference frame that may be used for attribute inter prediction but not for geometry inter prediction are implicitly stored in a linear buffer (without explicitly adding to the spherical reference table); their position in the linear access would continue to be defined.

As an example of a second set of problems, the spherical table construction for reference frame in inter prediction coding has several drawbacks. For example, currently each entry in the spherical table stores one or more 3-dimensional point (three dimensions are radius, azimuth and laserID). A potential solution is that the spherical table entry may comprise a 64-bit integer (e.g., uint64_t) that is obtained by packing the radius and azimuth. This enables more efficient storage of the table entries. Laser ID may be obtained from the look-up value. Another potential solution is that a spherical table may store index to linear buffer containing the points instead of storing the 3-dimensional point; this can result in memory buffer reduction. Typically size of index values are smaller than the combined sizes of radius, azimuth and laserID.

Another example problem is that the derivation of quantized azimuth uses an offset value. Offset needs an additional addition operation. Avoiding the addition can reduce computational complexity.

```
int computePhiQuantized(const int val) const
  {
    int offset = azimScaleLog2 ? (1 << (azimScaleLog2 - 1)) : 0;
    return val >= 0 ? (val + offset) >> azimScaleLog2
      : -((-val + offset) >> azimScaleLog2);
  }
```

A potential solution is to compute the quantized azimuth value from the azimuth value without using an offset. E.g., a bit shift operation may be sufficient.

In some examples, the entry may not store all bits of the azimuth as some bits of the azimuth may be obtained from the quantized azimuth value. Only subset of the azimuth bits may be stored in the entries for each point.

In some examples, restrictions may be applied to the bitdepth of radius and azimuth so that the smaller data structures could be used to represent the values. For example, instead of a 64-bit integer as described above, if the sum of the bit depth of radius and azimuth is less than 32 bits, then a 32-bit data unit may be sufficient to store each point in the entry table instead of 64 bits.

A third set of potential problems will now be introduced. Attributes may be identified in the SPS by the attribute index attrIdx based on the order in which the attributes are defined. Cross-attribute prediction (CAP) is used to decode attribute values from other attributes. When coding an attribute for a position, the values of previously coded attributes for the same position may be used in the decoding process (e.g., for prediction, for derivation of weights used for prediction, etc.). For CAP, the reference attribute is identified by refAttrIdx in the syntax table below, and is signaled in the APS, which refers to the attrIdx of the reference attribute. Currently, refAttrIdx is constrained to be in the range [0, num_attributes−1] and an attribute may only refer to one reference attribute.

| | |
|---|---|
| aps_extension_present | u(1) |
| if(aps_extension_present){ | |
| cross_attr_prediction_enabled_this_type | u(1) |
| if(cross_attr_prediction_enabled_this_type) | |
| refAttrIdx | ue(v) |
| if(attr_coding_type===0){ | |

cross_attr_prediction_enabled_this_type specifies whether (when 1) or not (when 0) the cross-attribute prediction is enabled for coding the current attribute if cross_attr_prediction_enabled is 1. When cross_attr_prediction_enabled_this_type is not present, it shall be inferred to be 0. It is a requirement of bitstream conformance that when cross_attr_prediction_enabled is 0, cross_attr_prediction_enabled_this_type shall be 0.
refAttrIdx specifies the index of attribute identified by its attrIdx that is used for decoding the current attribute. It shall range from 0 to num_attributes−1 when cross_attr_prediction_enabled_this_type is 1. When refAttrIdx is not present, it shall be inferred to be −1.

In conjunction with the third set of problems, the following deficiencies may be observed in the current design which may result in ambiguities or decoder crashes:
An attribute may refer to itself for prediction.
Circular referencing of attributes is permitted. E.g., if there are two attributes with index 0 and 1, current spec allows attribute 0 to refer to attribute 1 and vice versa. This is likely to result in a decoder crash on non-decodable bitstream
Chain referencing is also allowed; attribute with index 0 may refer to attribute 1, attribute 1 may refer to attribute 2, and so on. Adding more attributes in this chain adds to the worst-case latency of the codec when it is not clear whether such flexibility provides any benefit.

Potential solutions to the third set of problems will now be described. If chain referencing is disallowed, the following constraints may be sufficient to solve the above problems.
Add a constraint that attribute may not refer to itself for CAP. The constraint may be added as follows:
   For any attribute with attribute index attrIdx, the value of refAttrIdx shall not be equal to attrIdx.
Add a constraint that CAP shall be disabled for any attribute that is referred by another attribute by CAP. The constraint may be added as follows:
   For any attribute with attribute index attrIdx that refers to another attribute with attribute index refAttrIdx, the value of cross_attribute_prediction_enabled_this_type shall be equal to 0 for the attribute with attribute index equal to refAttrIdx.
If chain referencing is allowed, then the following conditions may need to be added.
   Add definition of direct and indirect reference attribute. The definition of direct and indirect reference may be defined using the following example.
      For a given attribute A (attrIdx equal to a) that refers to attribute B (attrIdx equal to b) using CAP such that refAttrIdx for attribute A is equal to b, attribute B is a direct reference attribute for attribute A. Any direct reference attribute of attribute B is an indirect reference attribute for attribute A. Furthermore, any indirect reference of attribute B is also an indirect reference of attribute A.
   Add a constraint that an attribute cannot be a direct or indirect reference attribute of itself.
   Add a constraint on the maximum number (N) of indirect reference attributes that is allowed. For example, in one example there may be a constraint that no attribute in the point cloud sequence may have any indirect reference frames (i.e., N=0). In other examples, the value of N may be limited to a fixed value (e.g., N=1). It must be noted that for N=0, direct reference frames are still allowed.

In some examples, there may be a restriction that CAP be disabled for any attribute that may be the first attribute in decoding order in any slice/frame (because such a first attribute may not have any prior decoded attribute from which it could predict).

In some examples, when one or more attribute values are not allowed to be referred by a given attribute, the binarization/signaling of refAttrIdx may be made simpler by removing those codewords thus reducing the average codeword length. E.g., if refAttrIdx cannot take value 0, then refAttrIdx minus 1 may be signaled in the bitstream. Or if refAttrIdx cannot take value attrIdx, then when refAttrIdx<attrIdx, refAttrIdx is signaled; when refAttrIdx>attrIdx, refAttrIdx−1 is signaled. Decoder performs the inverse operation to obtain the correct value of refAttrIdx.

As an example of a fourth problem, under cross-attribute prediction, when attribute A refers to attribute B, there is no restriction that attribute A follows attribute B in decoding order. This may result in unnecessary buffering if the attributes are not signaled in the correct order (if data units of attribute A arrives at decoder before data units of attribute B, data units of attribute A cannot be decoded before waiting and decoding data units of attribute B).

As an example of a potential solution to the fourth problem, a constraint may be added that when an attribute A refers to attribute B using CAP, data units (DUs) of attribute A in a slice shall not precede DUs of attribute B in the slice in decoding order. The constraint may be added as follows:
For any attribute with attribute index attrIdx that refers to another attribute with attribute index refAttrIdx, ADU with adu_sps_attr_idx equal to attrIdx belonging to a slice shall not precede, in decoding order, ADUs with adu_sps_attr_idx equal to refAttrIdx belonging to the same slice.
   ADU stands for attribute DU, GDU for geometry DU.

As an example of a fifth problem, control of geometry and attribute inter prediction is present at the DU (slice-level) using flags (there are flags at higher level in SPS/GPS/APS too). However, current signaling allows inter prediction to be enabled for the geometry and/or attributes of the first frame of the sequence. This is not desirable as there are no reference pictures for the first frame of the sequence.

As an example of a potential solution to the fifth problem, a constraint may be added that inter prediction is not enabled in GDUs and ADUs that belong to the first point cloud frame in the sequence.

As an example of a sixth problem, the E-GPCC specification supports the concept of fine granularity slices. Fine granularity slices (FGS) comprise of FGS geometry and FGS attributes and each FGS is associated with a layer group and a subgroup. Each FGS is mapped to a subgroup in a layer group. Layer group is a group of consecutive tree levels in the occupancy tree structure; each tree level belongs to only one layer group. A subgroup is a spatial subset of a layer group (defined by a bounding box) where a node in a tree level shall belong to only one subgroup in a layer group. The main benefit of FGS is the ability to generate a bitstream comprising a partial region of a point cloud frame which is very useful in applications that deal with very large points clouds (e.g., point cloud maps). A bitstream containing a partial region of the point cloud frame is easier to transmit and decode than the entire point cloud frame.

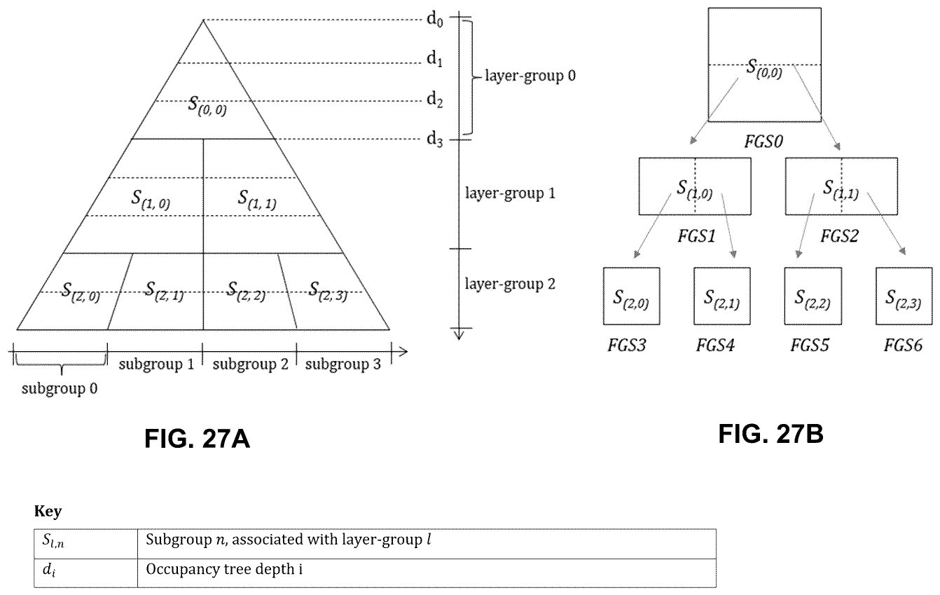

FIGS. 27A and 27B show a layer-group structure of an occupancy tree. Illustration (from E-GPCC Spec.): In FIG. 27A, a layer-group structure of an occupancy tree with maximum depth of 8 is depicted. In this example, three layer-groups are defined and each layer-group comprises tree levels from depth 0 to 3, 4 to 6, and 7 and 8, respectively. Except for the root layer-group, layer-groups may comprise subgroups. A subgroup is indicated by the pair consisting of the layer-group index and the subgroup index. For example, the root layer-group is indicated by (0, 0).

In FIG. 27B, the spatial region of subgroups from FIG. 27A are depicted by a rectangular bounding box in a xy-plane. When the bounding box of a subgroup in a layer-group is a superset of the bounding box of one or more subgroups in the next layer-group, the subgroups in adjacent layer-groups are in a parent and child relationship. In this example, subgroup (0,0) is the parent of subgroups (1,0) and (1,1). Similarly, subgroups (2,0) and (2,1) are children of subgroup (1,0). Each subgroup, indicated by a pair of layer-group index and subgroup index, is in different FGSs.

S_{l, n}represents Subgroup n, associated with layer-group 1, and d_irepresents occupancy tree depth i.

FGS geometry is signaled in geometry data units and geometry dependent data units. Similarly, FGS attributes are signaled in attribute data units and attributes dependent data units. The contexts used to parse the FGS geometry and attribute dependent data units are obtained from a previously coded data unit. This is indicated by ref_layer_group_id and ref_subgroup_id for geometry and attr_ref_layer_group_id and attr_ref_subgroup_id for attributes. For attributes, attr_ref_layer_group_id and attr_ref_subgroup_id may be either signaled explicitly (when attr_ref_id_present_flag is 1) or inferred from ref_layer_group_id and ref_subgroup_id, respectively (when attr_ref_id_present_flag is 0).

| | Descriptor |
|---|---|
| attribute_parameter_set( ) { | |
| ... | |
| if(fgs_layer_group_enabled) | |
| attr_ref_id_present_flag | u(1) |
| aps_extension_present | u(1) |
| if(aps_extension_present) { | |
| while(more_data_in_data_unit( )) | |
| aps_extension_data | u(1) |
| byte_alignment( ) | |
| } | |

A potential problem is that the syntax element attr_ref_id_present_flag is signaled in the APS. It is conditioned on fgs_layer_group_enabled that is signaled in the SPS. This leads to parsing dependence of the APS on the SPS which is not desirable. Generally, it is desirable to have the ability to parse a parameter set without depending on another parameter set.

As an example of a potential solution to the sixth problem:
Signal attr_ref_id_present_flag in the SPS directly conditioned under fgs_layer_group_enabled flag.
(Alternative 1) Signal attr_ref_id_present_flag in the APS without being conditioned on fgs_layer_group_enabled flag and add a constraint that when fgs_layer_group_enabled is 0, attr_ref_id_present_flag should also be 0.
(Alternative 2) attr_ref_id_present_flag is signaled in the attribute dependent data unit.

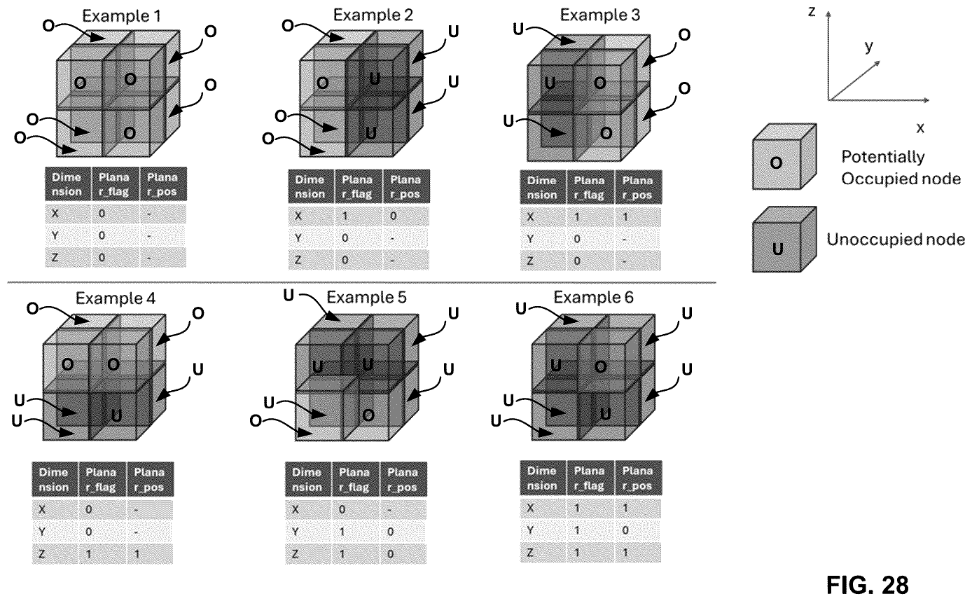

A potential seventh problem relates to E-GPCC supporting planar coding mode under octree geometry coding. Generally, for each node, the occupancy of each of the 8 child nodes is indicated by an occupancy flag. In planar coding mode, the occupancy of an octree node is first indicated by a set of up to three planar flags—each planar flag corresponds to one of the three geometry dimensions. The planar flag corresponding to a dimension specifies (when 1) whether all child nodes (if any) in the nodes occupy only half of the node split along the respective dimension (i.e., occupy a half-space); when planar flag is zero, the child nodes may or may not be restricted to one half space of the octree node split along the particular dimension. When the planar flag is equal to 1 along any dimension, a second flag planar_pos indicates which half of the octree is occupied (the other half is empty). When such indications exist, one or more flags signaling the occupancy of a particular child node is skipped (when signaling planar flag and planar_pos is cheaper than signaling the occupancy bits, there is coding efficiency). FIG. 28 shows some examples of planar_flag and planar_pos for different occupancy situations.

Each example in FIG. 28 shows the occupancy of 8 child nodes of an octree node. “O” represents a potentially occupied node, which for simplicity will be referred to as occupied nodes, and “U” represents an empty/unoccupied node. Possible values of planar_flag and planar_pos flag is given in each table associated with each example. The relative position of each node can be described as (x, y, z) where each of x, y, z could take values 0 or 1. E.g., bottom left node that is closer to the reader would be node (0, 0, 0) and bottom right node that is closer to the reader would be (1, 0, 0). Similarly, top right node farther from the reader would be (1, 1, 1) and so on.
1. Example 1: all the 8 child nodes are occupied. Hence planar_flag is 0 for all the three axes as nodes are not restricted to any half space.
2. Example 2: only four nodes are occupied and all the occupied nodes have x value 0. So planar_flag associated with x is 1 and the associated planar_pos flag is 0 (because all nodes have x value 0). Planar_flag for y and z are 0. In this case, signaling of occupancy bits of four nodes may be skipped.
3. Example 3: Similar to Example 2 but all the occupied nodes have x value 0. So planar_flag and planar_pos for x dimension are 1 and 1, respectively. Planar_flag for y and z are 0. In this case, signaling of occupancy bits of four nodes may be skipped.
4. Example 4: Similar to example 2 but all occupied nodes have z value equal 0. So planar_flag and planar_pos for z dimension are 1 and 0, respectively. Planar_flag for x and y are 0. In this case, signaling of occupancy bits of four nodes may be skipped.
5. Example 5: In this example, only two nodes are occupied and the occupied nodes have y equal to 0 and z equal to 0. So occupied nodes are restricted to half spaces in two dimensions. In this case planar_flag for both y and z are 1, the planar_pos for y and z are 0 and 0. Planar_flag for x is 0. In this case, signaling of occupancy bits of six nodes may be skipped.
6. Example 6: In this example, only one node is occupied and it corresponds to (1, 0, 1). So planar_flag for all 3 dimensions is 1 and planar_pos value for x, y, and z are 1, 0, and 1, respectively. In this case, signaling of occupancy bits of all nodes may be skipped as the planar_flag and planar_pos are sufficient to specify the occupancy of the node.

It is to be noted that when planar_flag is 1, it specifies that occupied nodes are within a half-space. However, when planar_flag is 0, it does not specify that nodes are present in both half spaces. The planar_flag equal to 0 only indicates that there is no such restriction. In other words, in all the above six examples, then encoder could have set planar_flag equal to 0 for all the three dimensions. The occupancy bits of all the eight child nodes may have had to be signaled in this case.

In G-PCC, the planar flag is not signaled for all the nodes to avoid signaling costs. Instead, a planar eligibility is determined for each of the three dimensions at each octree node and only if planar is determined to be eligible, then the planar_flag for that dimension is signaled. When geom_octree_depth_planar_eligibility_enabled_flag is equal to 1, planar eligibility is determined by estimating the density of points at an octree level. When geom_octree_depth_planar_eligibility_enabled_flag is 0, planar eligibility is determined by a “rate” of planar coding, i.e., based on history of number of nodes coded as planar mode and comparing the rate with a threshold (derived from the syntax elements octree_planar_threshold).

The signaling associated with planar eligibility by rate (shown between the delimiters <1> and </1>) and by density (shown between the delimiters <2> and </2>) is shown below:

| | |
|---|---|
| octree_planar_enabled | u(1) |
| if(octree_planar_enabled) { | |
| <1> for(i = 0; i < 3; i++) | |
| octree_planar_threshold[i] | ue(v)</1> |
| if(octree_direct_coding_mode == 1) | |
| octree_direct_node_rate_minus1 | u(5) |
| geom_multiple_planar_mode_enable_flag | u(1) |
| <2> geom_octree_depth_planar_eligibility_enabled_flag | u(1)</2> |
| } | |

A potential problem is that only one of the eligibility criteria (eligibility by density or eligibility by rate) is used at any point of time. The current signaling signals the planar thresholds and density-based eligibility flag for all cases. This signaling is redundant.

A potential solution is to signal the syntax elements associated with determining planar eligibility by rate only when the planar eligibility by density is not signaled. The modified syntax is shown between the delimiters 3> and u/3>.

| | |
|---|---|
| octree_planar_enabled | u(1) |
| if(octree_planar_enabled) { | |
| <3> geom_octree_depth_planar_eligibility_enabled_flag | u(1) |
| if(¬geom_octree_depth_planar_eligibility_enabled_flag) | |
| for(i = 0; i < 3; i++) | |
| octree_planar_threshold[i] | ue(v)</3> |
| if(octree_direct_coding_mode == 1) | |
| octree_direct_node_rate_minus1 | u(5) |
| geom_multiple_planar_mode_enable_flag | u(1) |
| } | |

In another example, the signaling of syntax elements associated with planar eligibility by rate or by density are only signaled when angular mode is disabled. This additional syntax is shown between the delimiters <4> and </4>. When angular mode is enabled, other methods may be used to determine eligibility.

| | |
|---|---|
| octree_planar_enabled | u(1) |
| if(octree_planar_enabled) { | |
| <4> if(¬geom_angular_enabled) {</4> | |
| <3> geom_octree_depth_planar_eligibility_enabled_flag | u(1) |
| if(¬geom_octree_depth_planar_eligibility_enabled_flag) | |
| for(i = 0; i < 3; i++) | |
| octree_planar_threshold[i] | ue(v) </3> |
| if(octree_direct_coding_mode == 1) | |
| octree_direct_node_rate_minus1 | u(5) |
| geom_multiple_planar_mode_enable_flag | u(1) |
| } | |

FIG. 19 is a block diagram illustrating an example of geometry encoding unit 250 of FIG. 2 in more detail. Geometry encoding unit 250 may include a coordinate transform unit 202, a voxelization unit 206, a prediction tree construction unit 207, an octree analysis unit 210, a surface approximation analysis unit 212, an arithmetic encoding unit 214, and a geometry reconstruction unit 216.

As shown in the example of FIG. 19, geometry encoding unit 250 may obtain a set of positions of points in the point cloud. In one example, geometry encoding unit 250 may obtain the set of positions of the points in the point cloud and the set of attributes from data source 104 (FIG. 1). The positions may include coordinates of points in a point cloud. Geometry encoding unit 250 may generate a geometry bitstream 203 that includes an encoded representation of the positions of the points in the point cloud.

Coordinate transform unit 202 may apply a transform to the coordinates of the points to transform the coordinates from an initial domain to a transform domain. This disclosure may refer to the transformed coordinates as transform coordinates. Voxelization unit 206 may voxelize the transform coordinates. Voxelization of the transform coordinates may include quantization and removing some points of the point cloud. In other words, multiple points of the point cloud may be subsumed within a single “voxel,” which may thereafter be treated in some respects as one point.

Prediction tree construction unit 207 may be configured to generate a prediction tree based on the voxelized transform coordinates. Prediction tree construction unit 207 may be configured to perform any of the prediction tree coding techniques described above, either in an intra-prediction mode or an inter-prediction mode. In order to perform prediction tree coding using inter-prediction, prediction tree construction unit 207 may access points from previously-encoded frames from geometry reconstruction unit 216. Dashed lines from geometry reconstruction unit 216 show data paths when inter-prediction is performed. Arithmetic encoding unit 214 may entropy encode syntax elements representing the encoded prediction tree.

Instead of performing prediction tree based coding, geometry encoding unit 250 may perform octree based coding. Octree analysis unit 210 may generate an octree based on the voxelized transform coordinates. Surface approximation analysis unit 212 may analyze the points to potentially determine a surface representation of sets of the points. Arithmetic encoding unit 214 may entropy encode syntax elements representing the information of the octree and/or surfaces determined by surface approximation analysis unit 212. Geometry encoding unit 250 may output these syntax elements in geometry bitstream 203. Geometry bitstream 203 may also include other syntax elements, including syntax elements that are not arithmetically encoded.

Octree-based coding may be performed either as intra-prediction techniques or inter-prediction techniques. In order to perform octree tree coding using inter-prediction, octree analysis unit 210 and surface approximation analysis unit 212 may access points from previously-encoded frames from geometry reconstruction unit 216. Dashed lines from geometry reconstruction unit 216 show data paths when inter-prediction is performed.

Geometry reconstruction unit 216 may reconstruct transform coordinates of points in the point cloud based on the octree, the predictive tree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points.

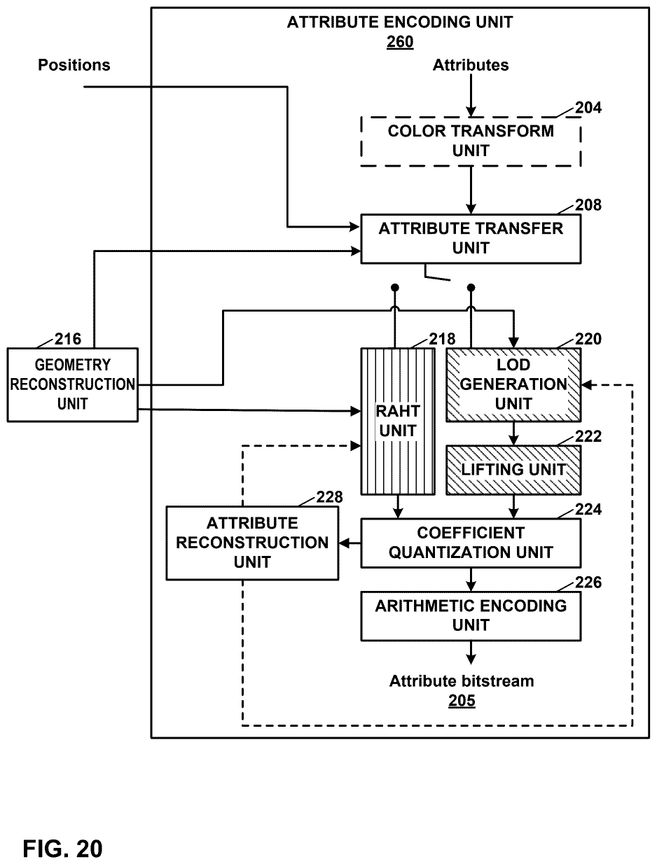

FIG. 20 is a block diagram illustrating an example of attribute encoding unit 260 of FIG. 2 in more detail. Attribute encoding unit 260 may include a color transform unit 204, an attribute transfer unit 208, an RAHT unit 218, a LoD generation unit 220, a lifting unit 222, a coefficient quantization unit 224, an arithmetic encoding unit 226, and an attribute reconstruction unit 228. Attribute encoding unit 260 may encode the attributes of the points of a point cloud to generate an attribute bitstream 205 that includes an encoded representation of the set of attributes. The attributes may include information about the points in the point cloud, such as colors associated with points in the point cloud.

Color transform unit 204 may apply a transform to transform color information of the attributes to a different domain. For example, color transform unit 204 may transform color information from an RGB color space to a YCbCr color space. Attribute transfer unit 208 may transfer attributes of the original points of the point cloud to reconstructed points of the point cloud. Attribute transfer unit 208 may use the original positions of the points as well as the positions generated from attribute encoding unit 250 (e.g., from geometry reconstruction unit 216) to make the transfer.

RAHT unit 218 may apply RAHT coding to the attributes of the reconstructed points. In some examples, under RAHT, the attributes of a block of 2×2×2 point positions are taken and transformed along one direction to obtain four low (L) and four high (H) frequency nodes. Subsequently, the four low frequency nodes (L) are transformed in a second direction to obtain two low (LL) and two high (LH) frequency nodes. The two low frequency nodes (LL) are transformed along a third direction to obtain one low (LLL) and one high (LLH) frequency node. The low frequency node LLL corresponds to DC coefficients and the high frequency nodes H, LH, and LLH correspond to AC coefficients. The transformation in each direction may be a 1-D transform with two coefficient weights. The low frequency coefficients may be taken as coefficients of the 2×2×2 block for the next higher level of RAHT transform and the AC coefficients are encoded without changes; such transformations continue until the top root node. The tree traversal for encoding is from top to bottom used to calculate the weights to be used for the coefficients; the transform order is from bottom to top. The coefficients may then be quantized and coded.

Alternatively or additionally, LoD generation unit 220 and lifting unit 222 may apply LoD processing and lifting, respectively, to the attributes of the reconstructed points. LoD generation is used to split the attributes into different refinement levels. Each refinement level provides a refinement to the attributes of the point cloud. The first refinement level provides a coarse approximation and contains few points; the subsequent refinement level typically contains more points, and so on. The refinement levels may be constructed using a distance-based metric or may also use one or more other classification criteria (e.g., subsampling from a particular order). Thus, all the reconstructed points may be included in a refinement level. Each level of detail is produced by taking a union of all points up to particular refinement level: e.g., LoD1 is obtained based on refinement level RL1, LoD2 is obtained based on RL1 and RL2, . . . LoDN is obtained by union of RL1, RL2, . . . RLN. In some cases, LoD generation may be followed by a prediction scheme (e.g., predicting transform) where attributes associated with each point in the LoD are predicted from a weighted average of preceding points, and the residual is quantized and entropy coded. The lifting scheme builds on top of the predicting transform mechanism, where an update operator is used to update the coefficients and an adaptive quantization of the coefficients is performed.

RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. G-PCC encoder 200 may output these syntax elements in attribute bitstream 205. Attribute bitstream 205 may also include other syntax elements, including non-arithmetically encoded syntax elements.

Like geometry encoding unit 250, attribute encoding unit 260 may encode the attributes using either intra-prediction or inter-prediction techniques. The above description of attribute encoding unit 260 generally describes intra-prediction techniques. In other examples, RAHT unit 218, LoD generation unit 220, and/or lifting unit 222 may also use attributes from previously-encoded frames to further encode the attributes of the current frame. In this regard, attribute reconstructions unit 228 may be configured to reconstruct the encoded attributes and store them for possible future use in inter-prediction encoding. Dashed lines from attribute reconstruction unit 228 show data paths when inter-prediction is performed.

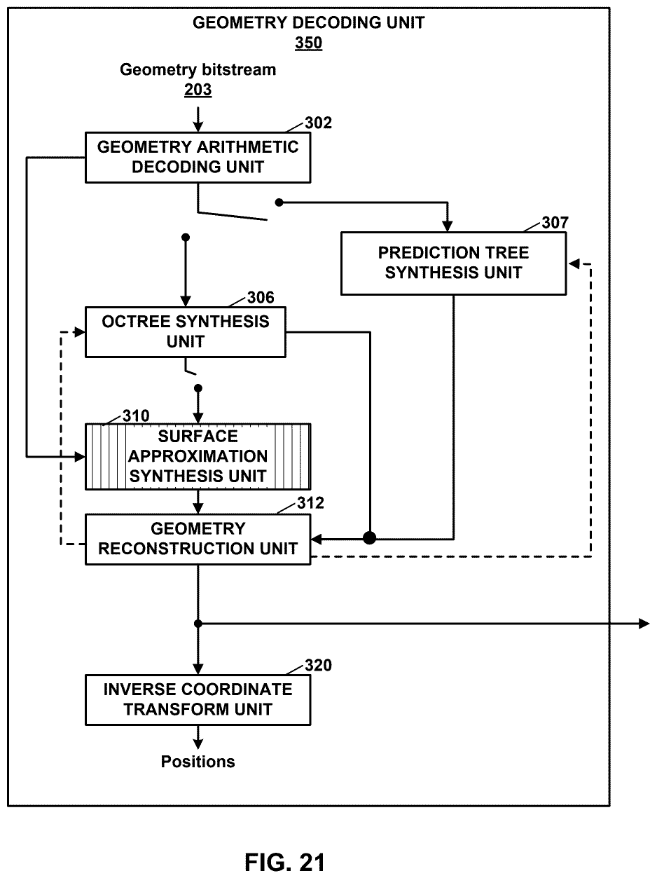

FIG. 21 is a block diagram illustrating an example geometry decoding unit 350 of FIG. 3 in more detail. Geometry decoding unit 350 may be configured to perform the reciprocal process to that performed by geometry encoding unit 250 of FIG. 19. Geometry decoding unit 350 receives geometry bitstream 203 and produces positions of the points of a point cloud frame. Geometry decoding unit 350 may include a geometry arithmetic decoding unit 302, an octree synthesis unit 306, a prediction tree synthesis unit 307, a surface approximation synthesis unit 310, a geometry reconstruction unit 312, and an inverse coordinate transform unit 320.

Geometry decoding unit 350 may receive geometry bitstream 203. Geometry arithmetic decoding unit 302 may apply arithmetic decoding (e.g., Context-Adaptive Binary Arithmetic Coding (CABAC) or other type of arithmetic decoding) to syntax elements in geometry bitstream 203. Octree synthesis unit 306 may synthesize an octree based on syntax elements parsed from geometry bitstream 203. Starting with the root node of the octree, the occupancy of each of the eight children node at each octree level is signaled in the bitstream. When the signaling indicates that a child node at a particular octree level is occupied, the occupancy of children of this child node is signaled. The signaling of nodes at each octree level is signaled before proceeding to the subsequent octree level.

At the final level of the octree, each node corresponds to a voxel position; when the leaf node is occupied, one or more points may be specified to be occupied at the voxel position. In some instances, some branches of the octree may terminate earlier than the final level due to quantization. In such cases, a leaf node is considered an occupied node that has no child nodes. In instances where surface approximation is used in geometry bitstream 203, surface approximation synthesis unit 310 may determine a surface model based on syntax elements parsed from geometry bitstream 203 and based on the octree. Octree-based coding may be performed either as intra-prediction techniques or inter-prediction techniques. In order to perform octree tree coding using inter-prediction, octree synthesis unit 306 and surface approximation synthesis unit 310 may access points from previously-decoded frames from geometry reconstruction unit 312. Dashed lines from geometry reconstruction unit 312 show data paths when inter-prediction is performed.

Prediction tree synthesis unit may synthesize a prediction tree based on syntax elements parsed from geometry bitstream 203. Prediction tree synthesis unit 307 may be configured to synthesize the prediction tree using any of the techniques described above, including using both intra-prediction techniques or intra-prediction techniques. In order to perform prediction tree coding using inter-prediction, prediction tree synthesis unit 307 may access points from previously-decoded frames from geometry reconstruction unit 312. Dashed lines from geometry reconstruction unit 312 show data paths when inter-prediction is performed.

Geometry reconstruction unit 312 may perform a reconstruction to determine coordinates of points in a point cloud. For each position at a leaf node of the octree, geometry reconstruction unit 312 may reconstruct the node position by using a binary representation of the leaf node in the octree. At each respective leaf node, the number of points at the respective leaf node is signaled; this indicates the number of duplicate points at the same voxel position. When geometry quantization is used, the point positions are scaled for determining the reconstructed point position values.

Inverse coordinate transform unit 320 may apply an inverse transform to the reconstructed coordinates to convert the reconstructed coordinates (positions) of the points in the point cloud from a transform domain back into an initial domain. The positions of points in a point cloud may be in floating point domain but point positions in G-PCC codec are coded in the integer domain. The inverse transform may be used to convert the positions back to the original domain.

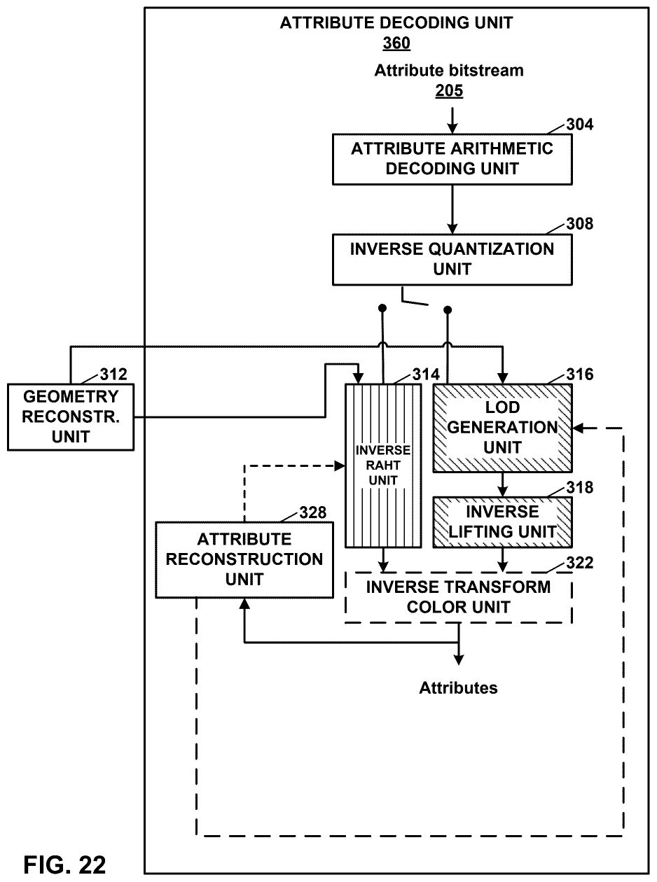

FIG. 22 is a block diagram illustrating an example attribute decoding unit 360 of FIG. 3 in more detail. Attribute decoding unit 360 may be configured to perform the reciprocal process to that performed by attribute encoding unit 260 of FIG. 20. Attribute decoding unit 360 receives attribute bitstream 205 and produces attributes of the points of a point cloud frame. Attribute decoding unit 360 may include an attribute arithmetic decoding unit 304, an inverse quantization unit 308, an inverse RAHT unit 314, an LoD generation unit 316, an inverse lifting unit 318, an inverse transform color unit 322, and an attribute reconstruction unit 328.

Attribute arithmetic decoding unit 304 may apply arithmetic decoding to syntax elements in attribute bitstream 205. Inverse quantization unit 308 may inverse quantize attribute values. The attribute values may be based on syntax elements obtained from attribute bitstream 205 (e.g., including syntax elements decoded by attribute arithmetic decoding unit 304).

Depending on how the attribute values are encoded, inverse RAHT unit 314 may perform RAHT coding to determine, based on the inverse quantized attribute values, color values for points of the point cloud. RAHT decoding is done from the top to the bottom of the tree. At each level, the low and high frequency coefficients that are derived from the inverse quantization process are used to derive the constituent values. At the leaf node, the values derived correspond to the attribute values of the coefficients. The weight derivation process for the points is similar to the process used at G-PCC encoder 200. Alternatively, LoD generation unit 316 and inverse lifting unit 318 may determine color values for points of the point cloud using a level of detail-based technique. LoD generation unit 316 decodes each LoD giving progressively finer representations of the attribute of points. With a predicting transform, LoD generation unit 316 derives the prediction of the point from a weighted sum of points that are in prior LoDs, or previously reconstructed in the same LoD. LoD generation unit 316 may add the prediction to the residual (which is obtained after inverse quantization) to obtain the reconstructed value of the attribute. When the lifting scheme is used, LoD generation unit 316 may also include an update operator to update the coefficients used to derive the attribute values. LoD generation unit 316 may also apply an inverse adaptive quantization in this case.

Furthermore, in the example of FIG. 22, inverse transform color unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, inverse transform color unit 322 may transform color information from the YCbCr color space to the RGB color space.

Attribute reconstruction unit 328 may be configured to store attributes from previously-decoded frames. Attribute coding may be performed either as intra-prediction techniques or inter-prediction techniques. In order to perform attribute decoding using inter-prediction, inverse RAHT unit 314 and/or LoD generation unit 316 may access attributes from previously-decoded frames from attribute reconstruction unit 328. Dashed lines from attribute reconstruction unit 328 show data paths when inter-prediction is performed.

The various units of FIGS. 19-22 are illustrated to assist with understanding the operations performed by G-PCC encoder 200 and G-PCC decoder 300. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

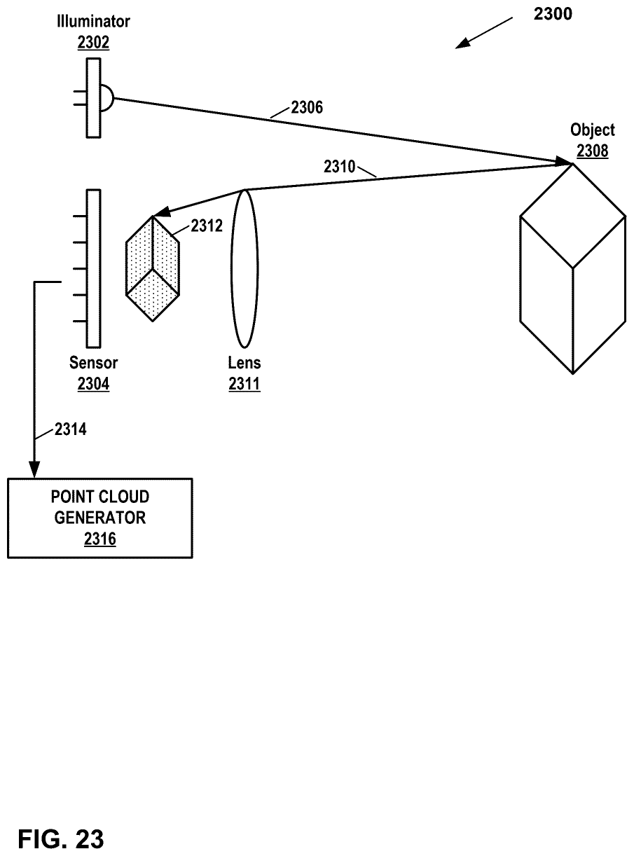

FIG. 23 is a conceptual diagram illustrating an example range-finding system 2300 that may be used with one or more techniques of this disclosure. In the example of FIG. 23, range-finding system 2300 includes an illuminator 2302 and a sensor 2304. Illuminator 2302 may emit light 2306. In some examples, illuminator 2302 may emit light 2306 as one or more laser beams. Light 2306 may be in one or more wavelengths, such as an infrared wavelength or a visible light wavelength. In other examples, light 2306 is not coherent, laser light. When light 2306 encounters an object, such as object 2308, light 2306 creates returning light 2310. Returning light 2310 may include backscattered and/or reflected light. Returning light 2310 may pass through a lens 2311 that directs returning light 2310 to create an image 2312 of object 2308 on sensor 2304. Sensor 2304 generates signals 2314 based on image 2312. Image 2312 may comprise a set of points (e.g., as represented by dots in image 2312 of FIG. 23).

In some examples, illuminator 2302 and sensor 2304 may be mounted on a spinning structure so that illuminator 2302 and sensor 2304 capture a 360-degree view of an environment (e.g., a spinning LIDAR sensor). In other examples, range-finding system 2300 may include one or more optical components (e.g., mirrors, collimators, diffraction gratings, etc.) that enable illuminator 2302 and sensor 2304 to detect ranges of objects within a specific range (e.g., up to 360-degrees). Although the example of FIG. 23 only shows a single illuminator 2302 and sensor 2304, range-finding system 2300 may include multiple sets of illuminators and sensors.

In some examples, illuminator 2302 generates a structured light pattern. In such examples, range-finding system 2300 may include multiple sensors 2304 upon which respective images of the structured light pattern are formed. Range-finding system 2300 may use disparities between the images of the structured light pattern to determine a distance to an object 2308 from which the structured light pattern backscatters. Structured light-based range-finding systems may have a high level of accuracy (e.g., accuracy in the sub-millimeter range), when object 2308 is relatively close to sensor 2304 (e.g., 0.2 meters to 2 meters). This high level of accuracy may be useful in facial recognition applications, such as unlocking mobile devices (e.g., mobile phones, tablet computers, etc.) and for security applications.

In some examples, range-finding system 2300 is a time of flight (ToF)-based system. In some examples where range-finding system 2300 is a ToF-based system, illuminator 2302 generates pulses of light. In other words, illuminator 2302 may modulate the amplitude of emitted light 2306. In such examples, sensor 2304 detects returning light 2310 from the pulses of light 2306 generated by illuminator 2302. Range-finding system 2300 may then determine a distance to object 2308 from which light 2306 backscatters based on a delay between when light 2306 was emitted and detected and the known speed of light in air). In some examples, rather than (or in addition to) modulating the amplitude of the emitted light 2306, illuminator 2302 may modulate the phase of the emitted light 2306. In such examples, sensor 2304 may detect the phase of returning light 2310 from object 2308 and determine distances to points on object 2308 using the speed of light and based on time differences between when illuminator 2302 generated light 2306 at a specific phase and when sensor 2304 detected returning light 2310 at the specific phase.

In other examples, a point cloud may be generated without using illuminator 2302. For instance, in some examples, sensors 2304 of range-finding system 2300 may include two or more optical cameras. In such examples, range-finding system 2300 may use the optical cameras to capture stereo images of the environment, including object 2308. Range-finding system 2300 may include a point cloud generator 2316 that may calculate the disparities between locations in the stereo images. Range-finding system 2300 may then use the disparities to determine distances to the locations shown in the stereo images. From these distances, point cloud generator 2316 may generate a point cloud.

Sensors 2304 may also detect other attributes of object 2308, such as color and reflectance information. In the example of FIG. 23, a point cloud generator 2316 may generate a point cloud based on signals 2314 generated by sensor 2304. Range-finding system 2300 and/or point cloud generator 2316 may form part of data source 104 (FIG. 1). Hence, a point cloud generated by range-finding system 2300 may be encoded and/or decoded according to any of the techniques of this disclosure. Inter prediction and residual prediction, as described in this disclosure may reduce the size of the encoded data.

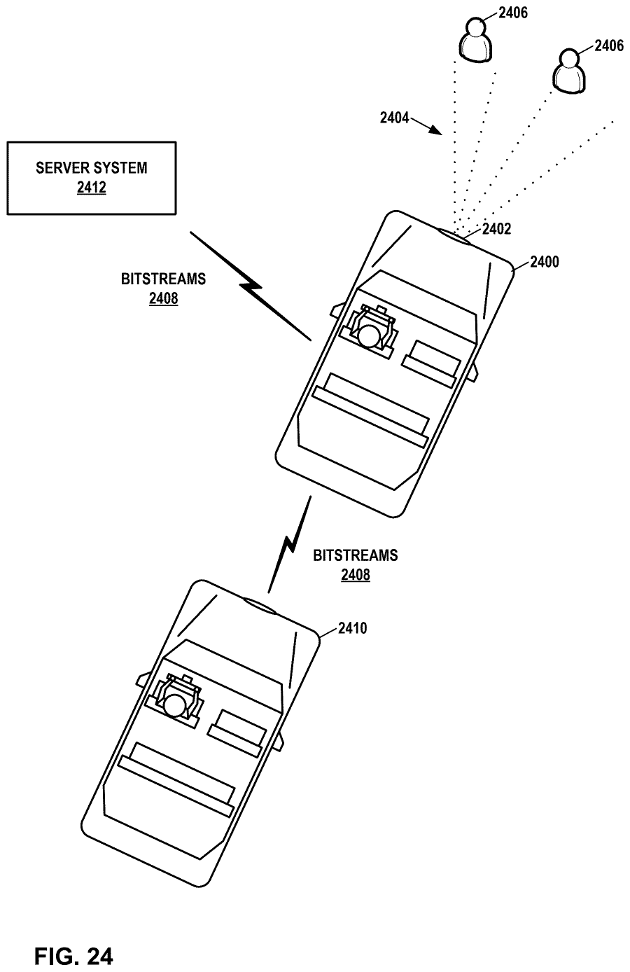

FIG. 24 is a conceptual diagram illustrating an example vehicle-based scenario in which one or more techniques of this disclosure may be used. In the example of FIG. 24, a vehicle 2400 includes a range-finding system 2402. Range-finding system 2402 may be implemented in the manner discussed with respect to FIG. 23. Although not shown in the example of FIG. 24, vehicle 2400 may also include a data source, such as data source 104 (FIG. 1), and a G-PCC encoder, such as G-PCC encoder 200 (FIG. 1). In the example of FIG. 24, range-finding system 2402 emits laser beams 2404 that reflect off pedestrians 2406 or other objects in a roadway. The data source of vehicle 2400 may generate a point cloud based on signals generated by range-finding system 2402. The G-PCC encoder of vehicle 2400 may encode the point cloud to generate bitstreams 2408, such as geometry bitstream (FIG. 2) and attribute bitstream (FIG. 2). Inter prediction and residual prediction, as described in this disclosure may reduce the size of the geometry bitstream. Bitstreams 2408 may include many fewer bits than the unencoded point cloud obtained by the G-PCC encoder.

An output interface of vehicle 2400 (e.g., output interface 108 (FIG. 1) may transmit bitstreams 2408 to one or more other devices. Bitstreams 2408 may include many fewer bits than the unencoded point cloud obtained by the G-PCC encoder. Thus, vehicle 2400 may be able to transmit bitstreams 2408 to other devices more quickly than the unencoded point cloud data. Additionally, bitstreams 2408 may require less data storage capacity on a device.

In the example of FIG. 24, vehicle 2400 may transmit bitstreams 2408 to another vehicle 2410. Vehicle 2410 may include a G-PCC decoder, such as G-PCC decoder 300 (FIG. 1). The G-PCC decoder of vehicle 2410 may decode bitstreams 2408 to reconstruct the point cloud. Vehicle 2410 may use the reconstructed point cloud for various purposes. For instance, vehicle 2410 may determine based on the reconstructed point cloud that pedestrians 2406 are in the roadway ahead of vehicle 2400 and therefore start slowing down, e.g., even before a driver of vehicle 2410 realizes that pedestrians 2406 are in the roadway. Thus, in some examples, vehicle 2410 may perform an autonomous navigation operation based on the reconstructed point cloud.

Additionally or alternatively, vehicle 2400 may transmit bitstreams 2408 to a server system 2412. Server system 2412 may use bitstreams 2408 for various purposes. For example, server system 2412 may store bitstreams 2408 for subsequent reconstruction of the point clouds. In this example, server system 2412 may use the point clouds along with other data (e.g., vehicle telemetry data generated by vehicle 2400) to train an autonomous driving system. In other example, server system 2412 may store bitstreams 2408 for subsequent reconstruction for forensic crash investigations.

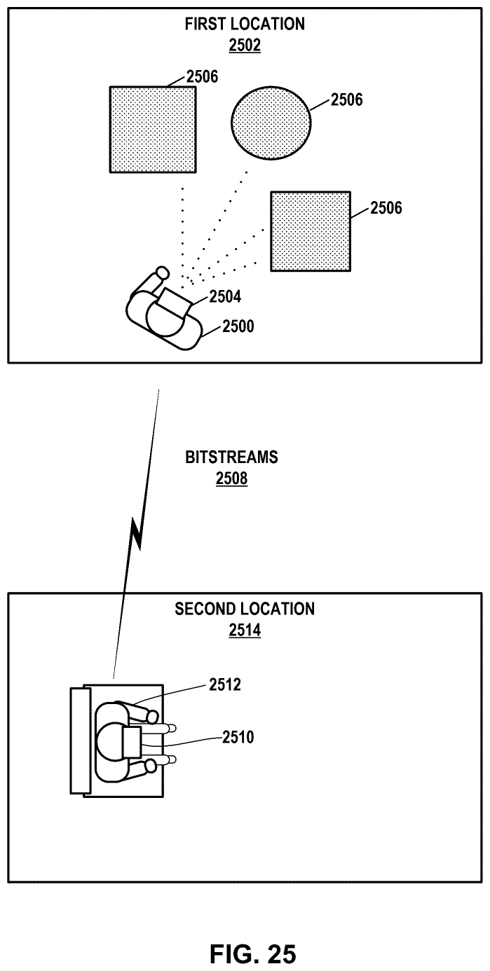

FIG. 25 is a conceptual diagram illustrating an example extended reality system in which one or more techniques of this disclosure may be used. Extended reality (XR) is a term used to cover a range of technologies that includes augmented reality (AR), mixed reality (MR), and virtual reality (VR). In the example of FIG. 25, a user 2500 is located in a first location 2502. User 2500 wears an XR headset 2504. As an alternative to XR headset 2504, user 2500 may use a mobile device (e.g., mobile phone, tablet computer, etc.). XR headset 2504 includes a depth detection sensor, such as a range-finding system, that detects positions of points on objects 2506 at location 2502. A data source of XR headset 2504 may use the signals generated by the depth detection sensor to generate a point cloud representation of objects 2506 at location 2502. XR headset 2504 may include a G-PCC encoder (e.g., G-PCC encoder 200 of FIG. 1) that is configured to encode the point cloud to generate bitstreams 2508. Inter prediction and residual prediction, as described in this disclosure may reduce the size of bitstream 2508.

XR headset 2504 may transmit bitstreams 2508 (e.g., via a network such as the Internet) to an XR headset 2510 worn by a user 2512 at a second location 2514. XR headset 2510 may decode bitstreams 2508 to reconstruct the point cloud. XR headset 2510 may use the point cloud to generate an XR visualization (e.g., an AR, MR, VR visualization) representing objects 2506 at location 2502. Thus, in some examples, such as when XR headset 2510 generates an VR visualization, user 2512 may have a 3D immersive experience of location 2502. In some examples, XR headset 2510 may determine a position of a virtual object based on the reconstructed point cloud. For instance, XR headset 2510 may determine, based on the reconstructed point cloud, that an environment (e.g., location 2502) includes a flat surface and then determine that a virtual object (e.g., a cartoon character) is to be positioned on the flat surface. XR headset 2510 may generate an XR visualization in which the virtual object is at the determined position. For instance, XR headset 2510 may show the cartoon character sitting on the flat surface.

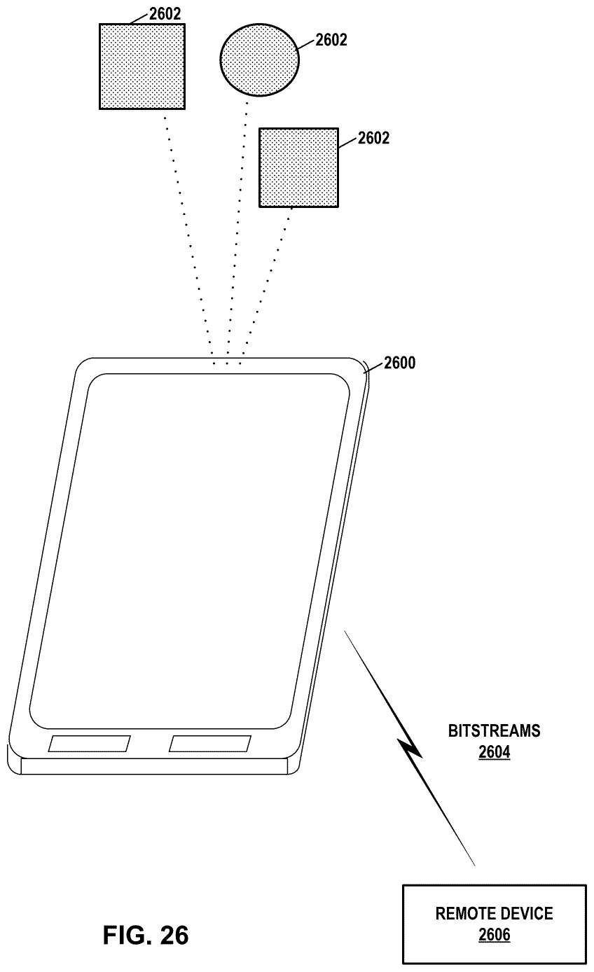

FIG. 26 is a conceptual diagram illustrating an example mobile device system in which one or more techniques of this disclosure may be used. In the example of FIG. 26, a mobile device 2600 (e.g., a wireless communication device), such as a mobile phone or tablet computer, includes a range-finding system, such as a LIDAR system, that detects positions of points on objects 2602 in an environment of mobile device 2600. A data source of mobile device 2600 may use the signals generated by the depth detection sensor to generate a point cloud representation of objects 2602. Mobile device 2600 may include a G-PCC encoder (e.g., G-PCC encoder 260 of FIG. 1) that is configured to encode the point cloud to generate bitstreams 2604. In the example of FIG. 26, mobile device 2600 may transmit bitstreams to a remote device 2606, such as a server system or other mobile device. Inter prediction and residual prediction, as described in this disclosure may reduce the size of bitstreams 2604. Remote device 2606 may decode bitstreams 2604 to reconstruct the point cloud. Remote device 2606 may use the point cloud for various purposes. For example, remote device 2606 may use the point cloud to generate a map of environment of mobile device 2600. For instance, remote device 2606 may generate a map of an interior of a building based on the reconstructed point cloud. In another example, remote device 2606 may generate imagery (e.g., computer graphics) based on the point cloud. For instance, remote device 2606 may use points of the point cloud as vertices of polygons and use color attributes of the points as the basis for shading the polygons. In some examples, remote device 2606 may use the reconstructed point cloud for facial recognition or other security applications.

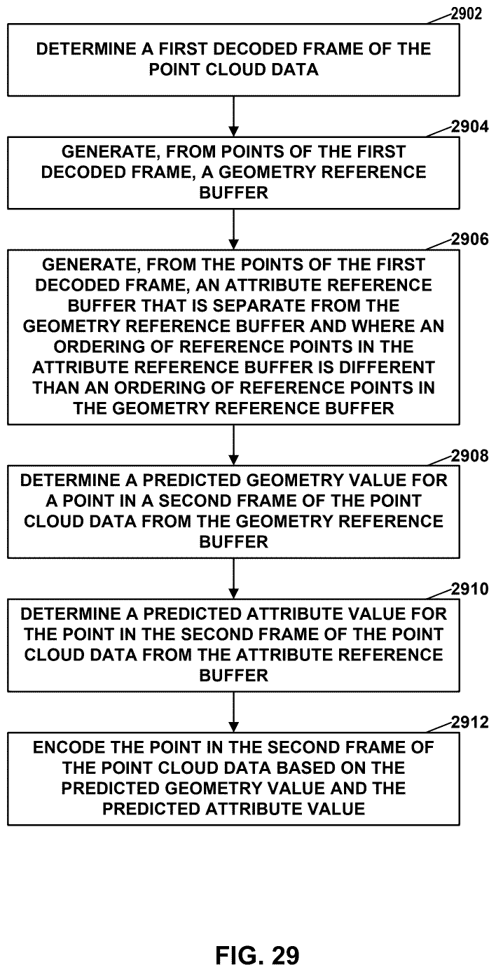

FIG. 29 is a flowchart illustrating an example process for encoding point cloud data. The process will be described as being performed by G-PCC encoder 200, although other types of G-PCC encoders may also perform the techniques of FIG. 29.

G-PCC encoder 200 may determine a first decoded frame of the point cloud data. In some examples, the first decoded frame may correspond to a first point cloud frame in a sequence of point cloud frames in a decoding order. The G-PCC encoder may disable inter prediction for geometry data units and attribute data units associated with the first point cloud frame.

G-PCC encoder 200 may generate, from points of the first decoded frame, a geometry reference buffer. The geometry reference buffer may comprise a look-up table that indexes a laser identification value and a quantized azimuth value to a radius value and an unquantized azimuth value.

G-PCC encoder 200 may generate, from the points of the first decoded frame, an attribute reference buffer. The attribute reference buffer is separate from the geometry reference buffer, and an ordering of reference points in the attribute reference buffer is different than an ordering of reference points in the geometry reference buffer. The attribute reference buffer may store attribute values for the reference points in a decoding order.

To generate the attribute reference buffer, G-PCC encoder 200 may process points of the first decoded frame in a decoding order. G-PCC encoder 200 may downsample the points of the first decoded frame in the attribute reference buffer to determine a downsampled reference frame. G-PCC encoder 200 may store the downsampled reference frame in the attribute reference buffer, wherein points in the downsampled reference frame are stored in a decoding order such that a relative order of the points in the downsampled reference frame matches a relative order of points in the first decoded frame.

G-PCC encoder 200 may determine a predicted geometry value for a point in a second frame of the point cloud data from the geometry reference buffer.

G-PCC encoder 200 may determine a predicted attribute value for the point in the second frame of the point cloud data from the attribute reference buffer. In some examples, G-PCC encoder 200 encoder may determine the predicted attribute value for the point in the second frame of the point cloud data from the downsampled reference frame.

To determine the predicted attribute value, G-PCC encoder 200 may identify a current attribute index for a current attribute associated with the point. G-PCC encoder 200 may identify a reference attribute index for a reference attribute. G-PCC encoder 200 may determine that the reference attribute index is different than the current attribute index. G-PCC encoder 200 may enable cross-attribute prediction for the current attribute using the reference attribute in response to determining that the reference attribute index is different than the current attribute index.

In some examples, G-PCC encoder 200 may identify a second attribute associated with a second point. G-PCC encoder 200 may identify a second current attribute index for the second attribute and a second reference attribute index for the second attribute. G-PCC encoder 200 may determine that the second reference attribute index is the same as the second current attribute index. G-PCC encoder 200 may disable cross-attribute prediction for the second attribute in response to determining that the second reference attribute index is the same as the second current attribute index.

G-PCC encoder 200 may encode the point in the second frame of the point cloud data based on the predicted geometry value and the predicted attribute value.

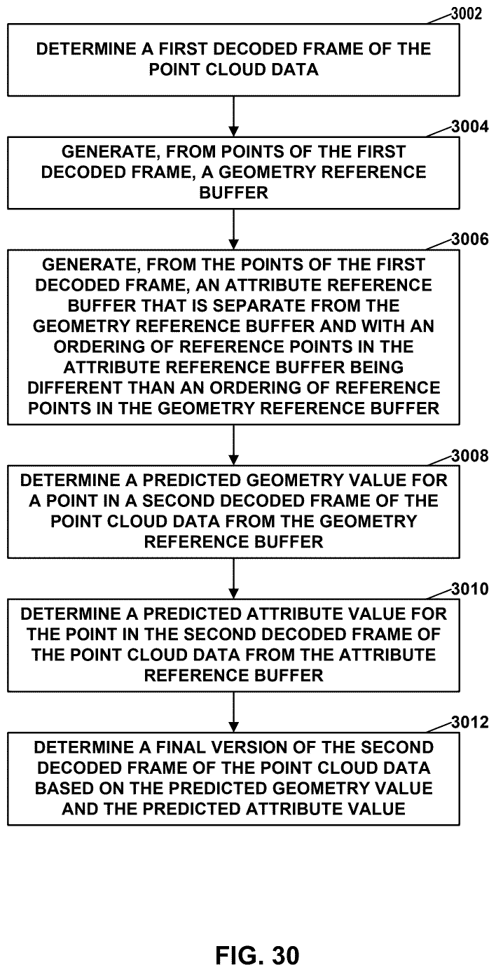

FIG. 30 is a flowchart illustrating an example process for decoding point cloud data. The process will be described as being performed by G-PCC decoder 300, although other types of G-PCC decoders may also perform the techniques of FIG. 30.

G-PCC decoder 300 may determine a first decoded frame of the point cloud data (3002). In some examples, the first decoded frame may correspond to a first point cloud frame in a sequence of point cloud frames in a decoding order. G-PCC decoder 300 may disable inter prediction for geometry data units and attribute data units associated with the first point cloud frame.

G-PCC decoder 300 may generate, from points of the first decoded frame, a geometry reference buffer (3004). The geometry reference buffer may comprise a look-up table that indexes a laser identification value and a quantized azimuth value to a radius value and an unquantized azimuth value.

G-PCC decoder 300 may generate, from the points of the first decoded frame, an attribute reference buffer (3006). The attribute reference buffer is separate from the geometry reference buffer, and an ordering of reference points in the attribute reference buffer is different than an ordering of reference points in the geometry reference buffer. The attribute reference buffer may store attribute values for the reference points in a decoding order.

To generate the attribute reference buffer, G-PCC decoder 300 may process points of the first decoded frame in a decoding order. G-PCC decoder 300 may downsample the points of the first decoded frame in the attribute reference buffer to determine a downsampled reference frame. G-PCC decoder 300 may store the downsampled reference frame in the attribute reference buffer, wherein points in the downsampled reference frame are stored in a decoding order such that a relative order of the points in the downsampled reference frame matches a relative order of points in the first decoded frame.

G-PCC decoder 300 may determine a predicted geometry value for a point in a second decoded frame of the point cloud data from the geometry reference buffer (3008).

G-PCC decoder 300 may determine a predicted attribute value for the point in the second decoded frame of the point cloud data from the attribute reference buffer (3010). In some examples, G-PCC decoder 300 may determine the predicted attribute value for the point in the second decoded frame of the point cloud data from the downsampled reference frame.

To determine the predicted attribute value, G-PCC decoder 300 may identify a current attribute index for a current attribute associated with the point. G-PCC decoder 300 may identify a reference attribute index for a reference attribute. G-PCC decoder 300 may determine that the reference attribute index is different than the current attribute index. G-PCC decoder 300 may enable cross-attribute prediction for the current attribute using the reference attribute in response to determining that the reference attribute index is different than the current attribute index.

In some examples, G-PCC decoder 300 may identify a second attribute associated with a second point. G-PCC decoder 300 may identify a second current attribute index for the second attribute and a second reference attribute index for the second attribute. G-PCC decoder 300 may determine that the second reference attribute index is the same as the second current attribute index. G-PCC decoder 300 may disable cross-attribute prediction for the second attribute in response to determining that the second reference attribute index is the same as the second current attribute index.

Additionally, G-PCC decoder 300 may identify a current attribute associated with the point, the current attribute having a current attribute index. G-PCC decoder 300 may identify a reference attribute associated with the point, the reference attribute having a reference attribute index. G-PCC decoder 300 may decode an attribute data unit corresponding to the reference attribute index before decoding an attribute data unit corresponding to the current attribute index.

G-PCC decoder 300 may determine a final version of the second decoded frame of the point cloud data based on the predicted geometry value and the predicted attribute value (3012).

G-PCC decoder 300 may reconstruct the point cloud based on the predicted attribute value for the point. In some examples, G-PCC decoder 300 may generate a map of an interior of a building based on the reconstructed point cloud. G-PCC decoder 300 may perform an autonomous navigation operation based on the reconstructed point cloud. G-PCC decoder 300 may generate computer graphics based on the reconstructed point cloud.

In some examples, G-PCC decoder 300 may determine a position of a virtual object based on the reconstructed point cloud and generate an extended reality (XR) visualization in which the virtual object is at the determined position.

The following numbered clauses illustrate one or more aspects of the devices and techniques described in this disclosure.

Clause 1A. A method of decoding point cloud data, the method comprising: maintaining a reference frame buffer according to any technique of this disclosure; and inter predicting a point of a point cloud based on a reference frame stored in the reference frame buffer.

Clause 2A. The method of clause 1A, further comprising generating the point cloud.

Clause 3A. The method of clause 1A, wherein the method is performed as part of an encoding process.

Clause 4A. A device for processing a point cloud, the device comprising one or more means for performing the method any of clauses 1A-3A.

Clause 5A. The device of clause 4A, wherein the one or more means comprise one or more processors implemented in circuitry.

Clause 6A. The device of any of clauses 4A or 5A, further comprising a memory to store the data representing the point cloud.

Clause 7A. The device of any of clauses 4A-6A, wherein the device comprises a decoder.

Clause 8A. The device of any of clauses 4A-7A, wherein the device comprises an encoder.

Clause 9A. The device of any of clauses 4A-8A, further comprising a device to generate the point cloud.

Clause 10A. The device of any of clauses 4A-9A, further comprising a display to present imagery based on the point cloud.

Clause 11A. A computer-readable storage medium having stored thereon instructions that, when executed, cause one or more processors to perform the method of any of clauses 1A-3A.

Clause 1B: A device for processing point cloud data, the device comprising: a memory configured to store the point cloud data; and one or more processors, implemented in circuitry, and configured to: determine a first decoded frame of the point cloud data; generate, from points of the first decoded frame, a geometry reference buffer; generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determine a predicted geometry value for a point in a second decoded frame of the point cloud data from the geometry reference buffer; determine a predicted attribute value for the point in the second decoded frame of the point cloud data from the attribute reference buffer; and determine a final version of the second decoded frame of the point cloud data based on the predicted geometry value and the predicted attribute value.

Clause 2B: The device of clause 1B, wherein the geometry reference buffer comprises a look-up table that indexes a laser identification value and a quantized azimuth value to a radius value and an unquantized azimuth value.

Clause 3B: The device of clause 1B or 2B, wherein the attribute reference buffer stores attribute values for the reference points in a decoding order.

Clause 4B: The device of any of clauses 1B-3B, wherein to generate the attribute reference buffer, the one or more processors are configured to: process points of the first decoded frame in a decoding order; downsample the points of the first decoded frame in the attribute reference buffer to determine a downsampled reference frame; store the downsampled reference frame in the attribute reference buffer, wherein points in the downsampled reference frame are stored in a decoding order such that a relative order of the points in the downsampled reference frame matches a relative order of points in the first decoded frame; and determine the predicted attribute value for the point in the second decoded frame of the point cloud data from the downsampled reference frame.

Clause 5B: The device of any of clauses 1B-4B, wherein to determine the predicted attribute value for the point in the second decoded frame of the point cloud data from the attribute reference buffer, the one or more processors are configured to: identify a current attribute index for a current attribute associated with the point; identify a reference attribute index for a reference attribute; determine that the reference attribute index is different than the current attribute index; and enable cross-attribute prediction for the current attribute using the reference attribute in response to determining that the reference attribute index is different than the current attribute index.

Clause 6B: The device of any of clauses 1B-5B, wherein the one or more processors are further configured to: identify a second attribute associated with a second point; identify a second current attribute index for the second attribute and a second reference attribute index for the second attribute; determine that the second reference attribute index is the same as the second current attribute index; and disable cross-attribute prediction for the second attribute in response to determining that the second reference attribute index is the same as the second current attribute index.

Clause 7B: The device of any of clauses 1B-5B, wherein to determine the predicted attribute value for the point in the second decoded frame of the point cloud data from the attribute reference buffer, the one or more processors are configured to: identify a current attribute associated with the point, the current attribute having a current attribute index; identify a reference attribute associated with the point, the reference attribute having a reference attribute index; and decode an attribute data unit corresponding to the reference attribute index before decoding an attribute data unit corresponding to the current attribute index.

Clause 8B: The device of any of clauses 1B-7B wherein to determine the first decoded frame of the point cloud data, the one or more processors are configured to: disable inter prediction for geometry data units and attribute data units associated with the first decoded frame in response to determining that the first decoded frame corresponds to a first point cloud frame in a sequence of point cloud frames in a decoding order.

Clause 9B: The device of any of clauses 1B-8B, wherein the one or more processors are further configured to reconstruct a point cloud based on the predicted attribute value for the point.

Clause 10B: The device of clause 9B, wherein the one or more processors are further configured to generate a map of an interior of a building based on the reconstructed point cloud.

Clause 11B: The device of clause 9B, wherein the one or more processors are further configured to perform an autonomous navigation operation based on the reconstructed point cloud.

Clause 12B: The device of clause 9B, wherein the one or more processors are further configured to generate computer graphics based on the reconstructed point cloud.

Clause 13B: The device of clause 9B, wherein the one or more processors are configured to: determine a position of a virtual object based on the reconstructed point cloud; and generate an extended reality (XR) visualization in which the virtual object is at the determined position.

Clause 14B: The device of clause 9B, further comprising a display to present imagery based on the reconstructed point cloud.

Clause 15B: The device of any of clauses 1B-14B, wherein the device is one of a mobile phone or tablet computer.

Clause 16B: The device of any of clauses 1B-14B, wherein the device is a vehicle.

Clause 17B: The device of any of clauses 1B-14B, wherein the device is an extended reality device.

Clause 18B: A method of decoding point cloud data, the method comprising: determining a first decoded frame of the point cloud data; generating, from points of the first decoded frame, a geometry reference buffer; generating, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determining a predicted geometry value for a point in a second decoded frame of the point cloud data from the geometry reference buffer; determining a predicted attribute value for the point in the second decoded frame of the point cloud data from the attribute reference buffer; and determining a final version of the second decoded frame of the point cloud data based on the predicted geometry value and the predicted attribute value.

Clause 19B: The method of clause 18B, wherein the geometry reference buffer comprises a look-up table that indexes a laser identification value and a quantized azimuth value to a radius value and an unquantized azimuth value.

Clause 20B: The method of clause 18B or 19B, wherein the attribute reference buffer stores attribute values for the reference points in a decoding order.

Clause 21B: The method of any of any of clauses 18B-20B, wherein generating the attribute reference buffer comprises: processing points of the first decoded frame in a decoding order; downsampling the points of the first decoded frame in the attribute reference buffer to determine a downsampled reference frame; storing the downsampled reference frame in the attribute reference buffer, wherein points in the downsampled reference frame are stored in a decoding order such that a relative order of the points in the downsampled reference frame matches a relative order of points in the first decoded frame; and determining the predicted attribute value for the point in the second decoded frame of the point cloud data from the downsampled reference frame.

Clause 22B: The method of any of clauses 18B-21B, wherein determining the predicted attribute value for the point in the second decoded frame of the point cloud data from the attribute reference buffer comprises: identifying a current attribute index for a current attribute associated with the point; identifying a reference attribute index for a reference attribute; determining that the reference attribute index is different than the current attribute index; and in response to determining that the reference attribute index is different than the current attribute index, enabling cross-attribute prediction for the current attribute using the reference attribute.

Clause 23B: The method of any of clauses 18B-22B, further comprising: identifying a second attribute associated with a second point; identifying a second current attribute index for the second attribute and a second reference attribute index for the second attribute; determining that the second reference attribute index is the same as the second current attribute index; and in response to determining that the second reference attribute index is the same as the second current attribute index, disabling cross-attribute prediction for the second attribute.

Clause 24B: The method of any of clauses 18B-23B, wherein determining the predicted attribute value for the point in the second decoded frame of the point cloud data from the attribute reference buffer comprises: identifying a current attribute associated with the point, the current attribute having a current attribute index; identifying a reference attribute associated with the point, the reference attribute having a reference attribute index; and decoding an attribute data unit corresponding to the reference attribute index before decoding an attribute data unit corresponding to the current attribute index.

Clause 25B: The method of any of clauses 18B-24B, wherein determining the first decoded frame of the point cloud data comprises: in response to determining that the first decoded frame corresponds to a first point cloud frame in a sequence of point cloud frames in a decoding order, disabling inter prediction for geometry data units and attribute data units associated with the first decoded frame.

Clause 26B: A computer-readable storage medium storing instructions that when executed by one or more processors cause the one or more processors to: determine a first decoded frame of point cloud data; generate, from points of the first decoded frame, a geometry reference buffer; generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determine a predicted geometry value for a point in a second decoded frame of the point cloud data from the geometry reference buffer; determine a predicted attribute value for the point in the second decoded frame of the point cloud data from the attribute reference buffer; and determine a final version of the second decoded frame of the point cloud data based on the predicted geometry value and the predicted attribute value.

Clause 27B: A device for encoding point cloud data, the device comprising: a memory configured to store the point cloud data; and one or more processors, implemented in circuitry, and configured to: determine a first decoded frame of the point cloud data; generate, from points of the first decoded frame, a geometry reference buffer; generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer; determine a predicted geometry value for a point in a second frame of the point cloud data from the geometry reference buffer; determine a predicted attribute value for the point in the second frame of the point cloud data from the attribute reference buffer; and encode the point in the second frame of the point cloud data based on the predicted geometry value and the predicted attribute value.

Clause 28B: The device of clause 27B, wherein the geometry reference buffer comprises a look-up table that indexes a laser identification value and a quantized azimuth value to a radius value and an unquantized azimuth value.

Clause 29B: The device of clause 27B or 28B, wherein the attribute reference buffer stores attribute values for the reference points in a decoding order.

Clause 30B: The device of any of clauses 27B-29B, wherein to generate the attribute reference buffer, the one or more processors are configured to: process points of the first decoded frame in a decoding order; downsample the points of the first decoded frame in the attribute reference buffer to determine a downsampled reference frame; store the downsampled reference frame in the attribute reference buffer, wherein points in the downsampled reference frame are stored in a decoding order such that a relative order of the points in the downsampled reference frame matches a relative order of points in the first decoded frame; and determine the predicted attribute value for the point in the second frame of the point cloud data from the downsampled reference frame.

Examples in the various aspects of this disclosure may be used individually or in any combination.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for processing point cloud data, the device comprising:
a memory configured to store the point cloud data; and
one or more processors, implemented in circuitry, and configured to:
determine a first decoded frame of the point cloud data;
generate, from points of the first decoded frame, a geometry reference buffer;
generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer;
determine a predicted geometry value for a point in a second decoded frame of the point cloud data from the geometry reference buffer;
determine a predicted attribute value for the point in the second decoded frame of the point cloud data from the attribute reference buffer; and
determine a final version of the second decoded frame of the point cloud data based on the predicted geometry value and the predicted attribute value.

2. The device of claim 1, wherein the geometry reference buffer comprises a look-up table that indexes a laser identification value and a quantized azimuth value to a radius value and an unquantized azimuth value.

3. The device of claim 1, wherein the attribute reference buffer stores attribute values for the reference points in a decoding order.

4. The device of claim 1, wherein to generate the attribute reference buffer, the one or more processors are configured to:
process points of the first decoded frame in a decoding order;
downsample the points of the first decoded frame in the attribute reference buffer to determine a downsampled reference frame;
store the downsampled reference frame in the attribute reference buffer, wherein points in the downsampled reference frame are stored in a decoding order such that a relative order of the points in the downsampled reference frame matches a relative order of points in the first decoded frame; and
determine the predicted attribute value for the point in the second decoded frame of the point cloud data from the downsampled reference frame.

5. The device of claim 1, wherein to determine the predicted attribute value for the point in the second decoded frame of the point cloud data from the attribute reference buffer, the one or more processors are configured to:
identify a current attribute index for a current attribute associated with the point;
identify a reference attribute index for a reference attribute;
determine that the reference attribute index is different than the current attribute index; and
enable cross-attribute prediction for the current attribute using the reference attribute in response to determining that the reference attribute index is different than the current attribute index.

6. The device of claim 1, wherein the one or more processors are further configured to:
identify a second attribute associated with a second point;
identify a second current attribute index for the second attribute and a second reference attribute index for the second attribute;
determine that the second reference attribute index is the same as the second current attribute index; and
disable cross-attribute prediction for the second attribute in response to determining that the second reference attribute index is the same as the second current attribute index.

7. The device of claim 1, wherein to determine the predicted attribute value for the point in the second decoded frame of the point cloud data from the attribute reference buffer, the one or more processors are configured to:
identify a current attribute associated with the point, the current attribute having a current attribute index;
identify a reference attribute associated with the point, the reference attribute having a reference attribute index; and
decode an attribute data unit corresponding to the reference attribute index before decoding an attribute data unit corresponding to the current attribute index.

8. The device of claim 1, wherein to determine the first decoded frame of the point cloud data, the one or more processors are configured to:
disable inter prediction for geometry data units and attribute data units associated with the first decoded frame in response to determining that the first decoded frame corresponds to a first point cloud frame in a sequence of point cloud frames in a decoding order.

9. The device of claim 1, wherein the one or more processors are further configured to reconstruct a point cloud based on the predicted attribute value for the point.

10. The device of claim 9, wherein the one or more processors are further configured to generate a map of an interior of a building based on the reconstructed point cloud.

11. The device of claim 9, wherein the one or more processors are further configured to perform an autonomous navigation operation based on the reconstructed point cloud.

12. The device of claim 9, wherein the one or more processors are further configured to generate computer graphics based on the reconstructed point cloud.

13. The device of claim 9, wherein the one or more processors are configured to:
determine a position of a virtual object based on the reconstructed point cloud; and
generate an extended reality (XR) visualization in which the virtual object is at the determined position.

14. The device of claim 9, further comprising a display to present imagery based on the reconstructed point cloud.

15. The device of claim 1, wherein the device is one of a mobile phone or tablet computer.

16. The device of claim 1, wherein the device is a vehicle.

17. The device of claim 1, wherein the device is an extended reality device.

18. A method of decoding point cloud data, the method comprising:
determining a first decoded frame of the point cloud data;
generating, from points of the first decoded frame, a geometry reference buffer;
generating, from the points of the first decoded frame, an attribute reference buffer, wherein the attribute reference buffer is separate from the geometry reference buffer and an ordering of reference points in the attribute reference buffer is different than an ordering of reference points in the geometry reference buffer;
determining a predicted geometry value for a point in a second decoded frame of the point cloud data from the geometry reference buffer;
determining a predicted attribute value for the point in the second decoded frame of the point cloud data from the attribute reference buffer; and
determining a final version of the second decoded frame of the point cloud data based on the predicted geometry value and the predicted attribute value.

19. The method of claim 18, wherein the geometry reference buffer comprises a look-up table that indexes a laser identification value and a quantized azimuth value to a radius value and an unquantized azimuth value.

20. The method of claim 18, wherein the attribute reference buffer stores attribute values for the reference points in a decoding order.

21. The method of claim 18, wherein generating the attribute reference buffer comprises:
processing points of the first decoded frame in a decoding order;
downsampling the points of the first decoded frame in the attribute reference buffer to determine a downsampled reference frame;
storing the downsampled reference frame in the attribute reference buffer, wherein points in the downsampled reference frame are stored in a decoding order such that a relative order of the points in the downsampled reference frame matches a relative order of points in the first decoded frame; and
determining the predicted attribute value for the point in the second decoded frame of the point cloud data from the downsampled reference frame.

22. The method of claim 18, wherein determining the predicted attribute value for the point in the second decoded frame of the point cloud data from the attribute reference buffer comprises:
identifying a current attribute index for a current attribute associated with the point;
identifying a reference attribute index for a reference attribute;
determining that the reference attribute index is different than the current attribute index; and
in response to determining that the reference attribute index is different than the current attribute index, enabling cross-attribute prediction for the current attribute using the reference attribute.

23. The method of claim 18, further comprising:
identifying a second attribute associated with a second point;
identifying a second current attribute index for the second attribute and a second reference attribute index for the second attribute;
determining that the second reference attribute index is the same as the second current attribute index; and
in response to determining that the second reference attribute index is the same as the second current attribute index, disabling cross-attribute prediction for the second attribute.

24. The method of claim 18, wherein determining the predicted attribute value for the point in the second decoded frame of the point cloud data from the attribute reference buffer comprises:
identifying a current attribute associated with the point, the current attribute having a current attribute index;
identifying a reference attribute associated with the point, the reference attribute having a reference attribute index; and
decoding an attribute data unit corresponding to the reference attribute index before decoding an attribute data unit corresponding to the current attribute index.

25. The method of claim 18, wherein determining the first decoded frame of the point cloud data comprises:
in response to determining that the first decoded frame corresponds to a first point cloud frame in a sequence of point cloud frames in a decoding order, disabling inter prediction for geometry data units and attribute data units associated with the first decoded frame.

26. A computer-readable storage medium storing instructions that when executed by one or more processors cause the one or more processors to:
determine a first decoded frame of point cloud data;
generate, from points of the first decoded frame, a geometry reference buffer;
generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer;
determine a predicted geometry value for a point in a second decoded frame of the point cloud data from the geometry reference buffer;
determine a predicted attribute value for the point in the second decoded frame of the point cloud data from the attribute reference buffer; and
determine a final version of the second decoded frame of the point cloud data based on the predicted geometry value and the predicted attribute value.

27. A device for encoding point cloud data, the device comprising:
a memory configured to store the point cloud data; and
one or more processors, implemented in circuitry, and configured to:
determine a first decoded frame of the point cloud data;
generate, from points of the first decoded frame, a geometry reference buffer;
generate, from the points of the first decoded frame, an attribute reference buffer, wherein the attribute reference buffer is separate from the geometry reference buffer and an ordering of reference points in the attribute reference buffer is different than an ordering of reference points in the geometry reference buffer;
determine a predicted geometry value for a point in a second frame of the point cloud data from the geometry reference buffer;
determine a predicted attribute value for the point in the second frame of the point cloud data from the attribute reference buffer; and
encode the point in the second frame of the point cloud data based on the predicted geometry value and the predicted attribute value.

28. The device of claim 27, wherein the geometry reference buffer comprises a look-up table that indexes a laser identification value and a quantized azimuth value to a radius value and an unquantized azimuth value.

29. The device of claim 27, wherein the attribute reference buffer stores attribute values for the reference points in a decoding order.

30. The device of claim 27, wherein to generate the attribute reference buffer, the one or more processors are configured to:
process points of the first decoded frame in a decoding order;
downsample the points of the first decoded frame in the attribute reference buffer to determine a downsampled reference frame;
store the downsampled reference frame in the attribute reference buffer, wherein points in the downsampled reference frame are stored in a decoding order such that a relative order of the points in the downsampled reference frame matches a relative order of points in the first decoded frame; and
determine the predicted attribute value for the point in the second frame of the point cloud data from the downsampled reference frame.
